(19) United States
(12) Patent Application Publication
(10) Pub. No.: US 2003/0204481 A1
(43) Pub. Date: Oct. 30, 2003

(54) Method and system for visually constructing XML schemas using an object-oriented model

(75) Inventor: Christina P. Lau, Scarborough (CA)

Correspondence Address: Jeffrey S. LaBaw, International Business Machines Corporation, Intellectual Property Law, 11400 Burnet Rd., Austin, TX, 78758, US

(73) Assignee: INTERNATIONAL BUSINESS MACHINES CORPORATION, Armonk, NY

(21) Appl. No.: 10/185,691

(22) Filed: Jun. 27, 2002

(30) Foreign Application Priority Data
Jul. 31, 2001 (CA) 2,354,443

(51) Int. Cl. G06F 7/00

(52) U.S. Cl. 707/1

(57) ABSTRACT

An object-oriented XML schema object model for use in a system for visualizing and constructing XML schemas is made up of a set of classes representative of various XML schema components or categories thereof including XML schema files, global XML schema file content, global elements, non-global elements, element content, include files, import files, type definitions generally, complex type definitions, complex type definition content, simple type definitions, built-in types, and attributes. The classes are implemented in an object-oriented programming language and are instantiated as necessary by the system in order to represent an XML schema being visually constructed. By virtue of their interrelationships, the instantiated classes cumulatively form an image or object tree which efficiently and logically represents an XML schema being visualized and/or constructed, and which may be easily navigated and modified during the execution of operations commonly encountered during XML schema visualization and construction.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This invention pertains to the field of extensible Markup Language (XML) schemas, and more particularly to the visualization and construction of XML schemas through use of an object-oriented XML schema model.

### BACKGROUND

In recent years, use of the extensible Markup Language has become increasingly prevalent in business. This trend is largely attributable to the flexibility of XML as a mechanism for defining the structure and content of data. XML allows users to define schemas comprising a set of elements and attributes (cumulatively referred to as “components”) in a structural relationship to define a particular data type. The elements and attributes defined in an XML schema may then be used as “tags” or labels in one or more XML data instances, each of which provides data content. XML schemas may be used in conjunction with generic compilers to generate or validate associated XML data instances. Thus, the definition and interpretation of various types of data between diverse applications and organizations can be facilitated. As well, because XML is ASCII-based, platform dependencies may be minimized or eliminated.

Traditionally, XML schemas have been created manually through the use of standard text editors. This method of schema creation is disadvantageous, however, in that it fails to promote good comprehension by the developer of the schema under development. This is the case because schemas constructed in this manner are entered and viewed textually. Moreover, schema creation through textual data entry is tedious and may be prone to typographical errors.

To promote easier generation of XML schemas, various alternative editors are now emerging into the market. These editors incorporate various features that are intended to facilitate XML schema creation and manipulation. For example, such an XML schema editor may display an XML schema graphically rather than textually, in order to promote improved visualization and comprehension of the schema. Such an editor may also permit a graphically-displayed XML schema to be manipulated through various types of graphical user interface techniques (e.g. pointing and clicking with a mouse and/or selecting menu commands) for the purpose of modifying or further defining the schema, in order to support easier schema development or maintenance. Such editors may further permit XML schema “source code” (i.e. ASCII XML which defines a schema) to be automatically generated from these graphical XML schema representations.

An XML schema that is developed by way of an XML alternative schema editor may be stored in the form of various data structures and/or dynamically declared variables. Unfortunately, if the data structures used to represent an XML schema are based on an XML schema data model that is not well-suited to the task of XML schema visualization and construction, the efficient operation of the XML schema editor may be negatively impacted in a variety of ways, e.g., the software implementing the XML schema editor may contain extraneous or redundant code, the size of the executable image may be larger than required, or the software's execution time may be unnecessarily lengthy. Furthermore, if the internal representation of an XML schema is not object-oriented, various benefits associated with object-oriented design, such as the benefits of polymorphism, inheritance, and encapsulation, as well as the prospect of improved comprehensibility of the source code, may be forfeited.

What is needed is an improved visualization and construction technique of an XML schema model, as well as a method and system for visually constructing XML schemas which can be used to efficiently and logically represent XML schemas.

### SUMMARY OF THE INVENTION

An object-oriented XML schema object model according to the present invention includes a set of classes representative of various XML schema components (i.e. elements or attributes), or categories of components, that are interrelated so as to promote efficient schema representation through inheritance and logical class interrelationships, and to promote efficient access to the schema's various components during the execution of operations commonly encountered during XML schema construction and visualization.

The model includes classes that are representative of such schema components and categories of components as XML schema files, global XML schema file content, global elements, non-global elements, element content, include files, import files, type definitions generally, complex type definitions, complex type definition content, simple type definitions, built-in types, and attributes. This set of classes is intended for implementation in an object-oriented programming language. When the classes have been so implemented, a system for visualizing and constructing XML schemas (such as an XML schema editor) instantiates the implemented classes as needed during operation in order to represent various XML schema components or component categories. The instantiated classes cumulatively form an image or object tree which efficiently and logically represents an XML schema being visualized and/or constructed, and which may be easily navigated and modified during the execution of operations commonly encountered during XML schema visualization and construction.

In accordance with an aspect of the present invention there is provided an object-oriented programming language implementation of an XML schema comprising an XML schema file class.

In accordance with another aspect of the present invention there is provided an object-oriented programming language implementation of an XML schema comprising at least one of: a global content class representative of global components of an XML schema file; a global element class representative of elements that are global to an XML schema; a non-global element class representative of elements that are not global to an XML schema; a type class representative of any of: a complex type definition; a simple type definition and a built-in type definition; a complex type definition class; a simple base type class representative of one of an XML schema built-in type and a simple type definition; a simple type definition class; a built-in type definition class; an attribute group class; an attribute class; a complex type content class representative of components that can be contained in a complex type definition; and an element content class representative of components that can be contained in an element declaration.

In accordance with yet another aspect of the present invention there is provided a Java™ language implementation of an XML schema comprising at least one of an XML schema file class, a global content class, a global element class, a non-global element class, an element content class, a type class, a complex type definition class, a complex type content class, a simple base type class, a built-in type class, a simple type class, an attribute group class, and an attribute class.

In accordance with still another aspect of the present invention there is provided a computer readable medium storing an object-oriented programming language implementation of an XML schema comprising at least one of an XML schema file class, a global content class, a global element class, a non-global element class, an element content class, a type class, a complex type definition class, a complex type content class, a simple base type class, a built-in type class, a simple type class, an attribute group class, and an attribute class.

In accordance with yet another aspect of the present invention there is provided a system for visually constructing XML schemas, comprising: a processor; and memory in communication with the processor, the memory containing an object-oriented programming language implementation of an XML schema comprising at least one of an XML schema file class, a global content class, a global element class, a non-global element class, an element content class, a type class, a complex type definition class, a complex type content class, a simple base type class, a built-in type class, a simple type class, an attribute group class, and an attribute class.

In accordance with still another aspect of the present invention there is provided a method of visually constructing XML schemas, the method comprising: instantiating at least one object from any of an XML schema file class, a global content class, a global element class, a non-global element class, an element content class, a type class, a complex type definition class, a complex type content class, a simple base type class, a built-in type class, a simple type class, an attribute group class, and an attribute class; and displaying at least one icon associated with the at least one object.

Other aspects and features of the present invention will become apparent to those ordinarily skilled in the art upon review of the following description of specific embodiments of the invention in conjunction with the accompanying figures.

### BRIEF DESCRIPTION OF FIGURES

FIG. 1 is a schematic diagram of an XML schema editing system exemplary of an embodiment of the present invention;

FIG. 2 illustrates a graphical user interface of the XML schema editing system of FIG. 1;

FIGS. 3A to 3I illustrate an XML schema object model exemplary of the present invention expressed in Unified Modeling Language (UML) notation;

FIG. 4 illustrates a flowchart of steps executed by the system of FIG. 1 during its operation;

FIGS. 5A, 5B and 5C illustrate an ASCII XML source code file comprising an XML schema which describes a purchase order; and

FIG. 6 is an XML schema image or “object tree” created by the system of FIG. 1 to represent the schema of FIGS. 5A, 5B and 5C.

### DETAILED DESCRIPTION

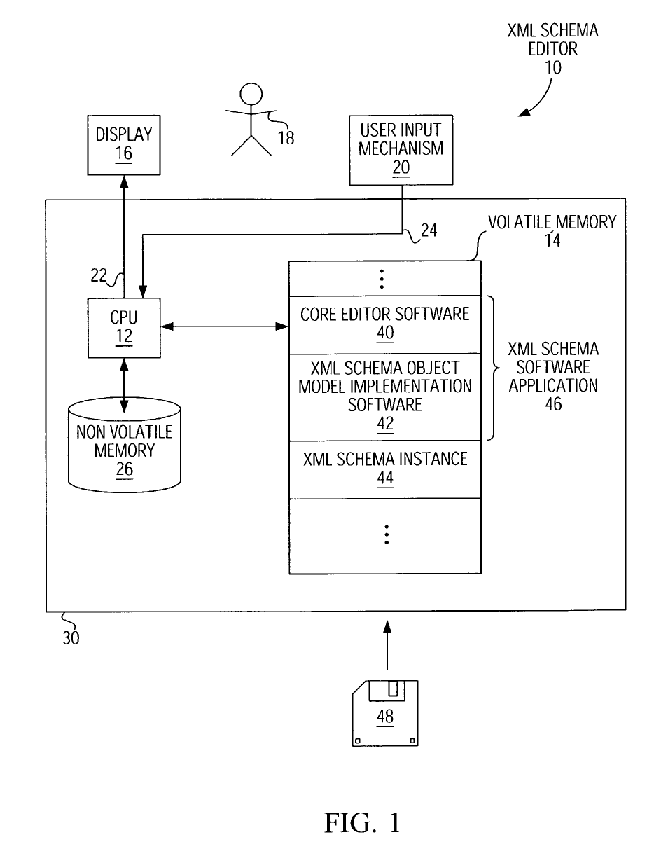

FIG. 1 illustrates an exemplary XML schema editing system 10 (also referred to as an “XML schema editor”) for visualizing and constructing XML schemas. The XML schema editor 10 comprises a computing device 30, such as a PC or server for example, executing an XML schema editor software application 46 stored in volatile memory 14 (e.g. RAM). The computing device includes a CPU 12 in communication with the volatile memory 14 as well as non-volatile memory 26, which may be a hard drive for example. The interconnections between the volatile and non-volatile memories 14 and 26 and the CPU 12 are conventional. A display 16 for displaying a graphical user interface (GUI) to a user 18 and a user input mechanism (UIM) 20 for receiving input from the user 18 are interconnected with the CPU 12 by way of links 22 and 24 respectively. The link 22 may not be a direct connection, and may for example include a video card (not shown) in communication with both the CPU 12 (by way of a system bus) and a monitor (by way of a cable) in a conventional manner. The interconnection of the user input mechanism 20 with the CPU 12 is also conventional and may not be direct.

Display 16 is a conventional display device, such as a CRT monitor or flat-screen display, capable of presenting a graphical user interface for visualizing and constructing XML schemas, as will be described, to a user 18. The display 16 may form part of the computing device 30 comprising the XML schema editor 10.

The user input mechanism 20 is a device capable of generating user input representative of commands for visualizing and constructing an XML schema. The UIM 20 may be a keyboard, mouse or touch screen, for example, and may be capable of controlling a movable pointer on the display 16 for identifying or selecting displayed XML schema components and to execute various XML schema editing commands. The user input mechanism 20 may form part of the computing device 30 which comprises the editor 10.

XML schema editor software application 46 may be loaded into the volatile memory 14 of the system 10 from any suitable computer readable medium, such as a removable optical or magnetic disk 48, or from resident non-volatile memory 26 such as a hard drive or a read only memory chip.

The XML schema editor software application 46 is comprised of two parts: the “core” editor application software 40 and the XML schema object model implementation software 42.

The core editor application software 40 comprises executable code which implements key aspects of the functionality of the editor 10, such as the graphical user interface and event-driven command processing. The commands that the software 40 is capable of processing are for the loading, construction or modification of XML schema, e.g. “open an XML schema”, “add a new XML element to the schema”, “delete an element”, and so on, as will be described in greater detail subsequently.

The XML schema object model implementation software 42 comprises executable code which implements an XML schema object model. The XML schema object model is an object-oriented “template” for an XML schema comprising a set of classes representative of XML schema components (i.e. elements or attributes, such as annotation elements, complex type definitions, attributes, etc.), or categories of such components, as will be described in detail subsequently. The model's classes are interrelated, through inheritance and various logical associations (e.g. composition or bi-directional association), so as to promote efficient and logical representation of a visualized or constructed XML schema and efficient access to the schema's various components during operations that are commonly encountered during XML schema visualization and construction (e.g. determining which elements are global to an XML schema for the purpose of creating a list from which a user may pick during element reference creation, deleting a component from an XML schema, etc.).

It will be appreciated that, because the classes comprising the model are not tied to any particular implementation or programming language, to permit them to be incorporated into an application such as editor 10 they should first be realized in an object-oriented language such as Java™ or C++. It is the realized classes (comprising the software 42) that are instantiated by the editor 10 at run time during the course of XML schema visualization and construction. Individually, the various objects which may be instantiated represent various types of XML schema component components (or categories thereof) of an XML schema that is being displayed and/or edited. Cumulatively, the instantiated objects are interrelated by way of instantiated class interrelationships so as to form an instance or “object tree” 44 of the overall schema in volatile memory 14. This object tree 44 is designed to be efficiently and logically navigable during the course of schema visualization and construction, e.g. in response to a user's entered commands during XML schema editing. It will be appreciated that the object tree 44 only exists during the operation of the XML schema editor 10.

Thus, the core software 40 essentially implements a run-time event handling “loop”, and the XML schema object model application software 42 is invoked as necessary from that the software 40 (during the course of the handling of various system events) for the purpose of creating, manipulating or destroying objects which represent an XML schema.

In the sections that follow, the GUI and other features of the core editor software 40 will first be described in order to illustrate the functionality of an exemplary XML schema editor and to provide an understanding of the type of features that the XML schema object model is intended to support. Thereafter, the XML schema object model will be described in some detail. The operation of the editor will be described.

It will be appreciated that, in order to best comprehend the description that follows, an understanding of XML and XML schemas is necessary. In the event that such an understanding is incomplete, the reader is referred to the text XML Applications by Frank Boumphrey et al., 1998, Wrox Press, for clarification, which text is hereby incorporated by reference herein.

Editor GUI and Features

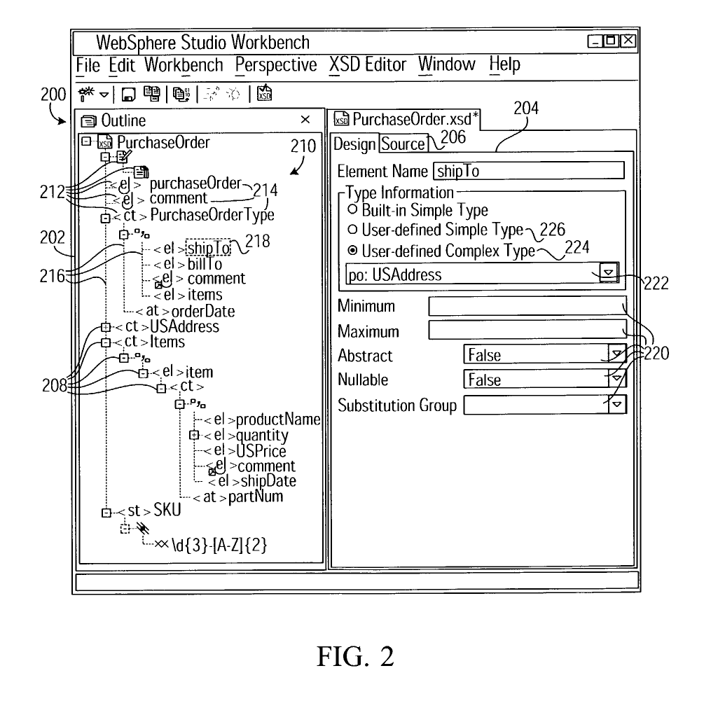

FIG. 2 illustrates an exemplary graphical user interface 200 of the system 10 that is generated by the core editor application software 40 for presentation to a user 18 on the display 16. The layout and features of the GUI 200 are designed to support the objective of visualizing and constructing XML schemas. The interface 200 includes a content outline pane 202, a design pane 204 and a source code pane 206.

The content outline pane 202 of the user interface 200 in FIG. 2 includes an content outline 210 of an exemplary XML schema that is being edited. The content outline 210 promotes improved comprehension of the XML schema (as compared with viewing textual XML source code for example) by providing a visualization of the XML schema hierarchy “at a glance”. Content outline 210 is a tree-like hierarchical structure comprising XML schema entity icons 212 interconnected by dotted-line hierarchy indicators 216. The icons 212 represent various XML schema components (e.g. annotation elements, complex types definitions, attributes, etc.) which make up the XML schema being edited. The appearance of the icons 212 reflects the type of XML elements being represented.

Each of the icons 212 is optionally accompanied by neighboring text 214. Neighboring text 214 represents the value of an attribute of the XML element represented by the associated icon, such as the “name” attribute which is common to many XML schema components. The hierarchy indicators 216 between the icons 212 show the hierarchical interrelationships between the various XML schema component objects represented by the icons 212. The hierarchy indicators 216 are analogous to directory hierarchy indicators commonly utilized in file management utilities of windowed computer operating systems. An expansion symbol 208 beside an XML element icon allows the “children” of that XML element to be displayed or hidden. When a symbol 208 is selected and thereby toggled, the content outline 210 expands or collapses accordingly.

The icons 212 in the content outline 210 are selectable by way of a pointer (not shown) that is controlled by the user input mechanism 20. Selection of an icon will result in a change in the icon's appearance (e.g. text becomes highlighted, as illustrated with respect to icon 218) to reflect the fact that the icon and the corresponding XML element have been selected. Information regarding the currently selected XML element 218 is displayed in design pane 204. The information displayed in pane 204 comprises the current attributes and attribute values of the selected XML element 218. Attribute values are displayed in text fields 220 which may be editable to permit an XML schema elements' attribute values to be modified during the course of schema development.

Certain fields in the design pane 204 may contain various tailored pull-down lists of currently defined XML schema components. These pull-down lists are dynamically created and updated by the software 46 to include only currently defined XML schema components. Items from the list may be selected by a user 18 in a convenient method of choosing a currently-defined XML schema object from (possibly) multiple defined objects during the course of various schema editing operations. For example, when a user selects an XML element (either a global element or a local element) or attribute for the purpose of setting its type to a user-defined simple or complex type, a list of currently available user-defined types may be displayed. Alternatively, when a user selects an element reference, group reference, key reference, or attribute group reference in order to specify the entity that is being referenced, a list of current globally-defined components of the appropriate kind may be displayed.

The source code pane 206 (only partially visible in FIG. 2) shows the XML schema under development in the form of textual (ASCII) XML source code containing tags, elements, attributes, etc. Any changes made to the XML schema by the user 18 through interaction with the graphical content outline 210 in pane 202 are reflected in the source code pane 206 through the automatic updating of the XML source code by the software 46. In that sense the functionality of the XML schema editor 10 may be compared to the functionality of such Hypertext Markup Language (HTML) editors as Microsoft® FrontPage®, which permits a developer to manipulate a world wide web page in graphical form to generate corresponding HTML source code automatically. When an XML schema component (e.g. a complex type) is selected in the content outline pane 202, the corresponding XML source code is highlighted in the source code pane 206, in order to emphasize the correlation between the highlighted schema component and its corresponding source code.

The list of available actions displayed in the GUI 200 by the software 40 (e.g. in the form of a floating menu of options which “pops up” when a right mouse button is depressed) is dependent upon the type of XML schema component object that is currently selected. The displayed options are dynamically updated to include only actions that are logical for the XML schema component object that is currently selected in the content outline 210. For example, if the currently-selected XML icon/element is of type “attribute group”, the set of available actions is limited to “Add Annotation”, “Add Attribute”, and “Delete Attribute Group”, since only these actions may be performed to attribute groups.

The set of available actions for various selected XML schema component objects is described in Table I below:

TABLE I
Context-sensitive Actions for Various XML Schema Objects

| Selected XML | |
|---|---|
| Schema | |
| Component | |
| Object Type | Available Actions |
| 1. XML schema | a) Add Annotation. This action adds an |
| file object | annotation element to the XML Schema. |
| | b) Add Global Element. This action adds a |
| | global element to the XML Schema. |
| | c) Add Complex Type. This action adds a complex |
| | type to the XML schema. |
| | d) Add Simple Type. This action adds a simple |
| | type to the XML schema. |
| | e) Add Attribute Group. This action adds an |
| | attribute group to the XML schema. An |
| | attribute group contains a number of |
| | attributes, and can be referenced by |
| | multiple definitions. It improves the |
| | readability and maintainability of the |
| | schema. |
| | f) Add Group. This action adds a global model |
| | group to the XML schema. A group contains a |
| | number of elements, and can be used to build |
| | up the content model of a complex type. |
| | g) Add Include. This action adds an include |
| | element to the XML schema. An include |
| | element brings in definitions and |
| | declarations from an XML schema file in the |
| | same target namespace as the current schema. |
| | h) Add Import. This action adds an import |
| | element to the XML schema. An import element |
| | brings in definitions and declarations from |
| | an XML schema file in a different namespace. |
| | i) Delete XML schema file object. This action |
| | deletes the currently selected XML schema |
| | file object from the schema. |
| 2. Complex Type | j) Add Annotation. This action adds an |
| object | annotation element to a complex type. |
| | k) Add Content Model. This action adds a |
| | sequence element to a complex type. |
| | l) Add Group. This action adds a group element |
| | to a complex type. |
| | m) Add Simple Content. This action adds a |
| | simple content object to a complex type. |
| | n) Add Complex Content. This action adds a |
| | complex content object to a complex type. |
| | o) Add Attribute. This action adds an attribute |
| | to a complex type's content. |
| | p) Add Attribute Group Ref. This action adds an |
| | attribute group reference to a complex type. |
| | This menu option only appears if at least |
| | one attribute group is defined in the XML |
| | schema. |
| | q) Delete complex type object. This action |
| | deletes the currently selected complex type |
| | object from the schema (see Table II below |
| | for a description of the referential |
| | integrity processing which occurs upon such |
| | deletion). |
| 3. Simple Type | r) Add Annotation. This action adds an |
| object | annotation element to a simple type. |
| | s) Add Restriction. This action adds a |
| | restriction element to a simple type. |
| | t) Add Union. This action adds a union element |
| | to a simple type. |
| | u) Add List. This action adds a list element to |
| | a simple type. |
| | v) Add Enum. This action adds an enumeration to |
| | a simple type. This menu option only appears |
| | if the enumeration facet is applicable to |
| | the base type of the simple type. |
| | w) Add Pattern. This action adds a pattern to |
| | the simple type. This menu option only |
| | appears if the pattern facet is applicable |
| | to the base type of the simple type. |
| | x) Delete simple type object. This action |
| | deletes the currently selected simply type |
| | object from the schema (see Table II below |
| | for a description of the referential |
| | integrity processing which occurs upon such |
| | deletion). |
| 4. Attribute | y) Add Annotation. This action adds an |
| Group object | annotation element to an attribute group. |
| | z) Add Attribute. This action adds an attribute |
| | to an attribute group. |
| | aa) Delete attribute group. This action deletes |
| | the currently selected attribute group from |
| | the schema (see Table II below for a |
| | description of the referential integrity |
| | processing which occurs upon such deletion). |
| 5. Content Model | ab) Add Group. This action adds a group element. |
| object | ac) Add Group Reference. This action adds a |
| | reference to a global group. |
| | ad) Add Element. This action adds an element to |
| | the content of the complex type. |
| | ae) Add Element Ref. This action adds a |
| | reference to a global element. This menu |
| | option only appears if there are global |
| | elements defined else where in the document. |
| | af) Delete content model. This action deletes |
| | the currently selected content model from |
| | the schema. |
| 6. Element or | ag) Add Annotation. This action adds an |
| Global Element | annotation object to an element. |
| object | ah) Add Unique. This action adds a “unique” |
| | object to an element which indicates that an |
| | element or attribute value must be unique |
| | within a certain scope. |
| | ai) Add Key. This action adds a “key” object to |
| | the element. |
| | aj) Add Key Reference. This action adds a |
| | reference to a key to an element. |
| | ak) Delete element. This action deletes the |
| | currently selected element from the schema |
| | (see Table II below for a description of the |
| | referential integrity processing which |
| | occurs upon deletion of global elements). |
| 7. Annotation | al) Add Documentation. This action adds a |
| object | documentation element to the annotation |
| | object for storing human-readable material. |
| | am) Add AppInfo. This action adds an appInfo |
| | element to the annotation object for storing |
| | information for tools, stylesheets and other |
| | applications . |
| | an) Delete annotation object. This action |
| | deletes the currently selected annotation |
| | object from the schema. |

When certain of the actions described above are selected and executed, the addition or deletion of an XML schema entity to or from the schema may result. The core editor software 40 is capable of effecting this change by inserting or removing an icon representative of the added or deleted object into or from the content outline 210. The content model 210 displayed in pane 202 may thus grow or shrink accordingly. This dynamic growing and shrinking of the displayed content model 210 provides the user with a continuously updated view of the XML schema under development.

Deletion of certain XML schema component objects triggers referential integrity processing in the XML schema editor application software 46. The purpose of referential integrity processing is to prevent any “orphan” or “artifact” references to deleted objects from being left in the schema. The nature of the referential integrity processing that is triggered is dependent upon the type of XML schema component object being deleted. The various different types of referential integrity processing are summarized in Table II below:

TABLE II
Referential Integrity Processing for Deleted XML Schema Objects

| Deleted XML Schema | |
|---|---|
| Object Type | Referential Integrity Processing |
| 1. Global Element | a) If at least one global element remains in |
| | the current schema file (or in a schema file |
| | referenced from an “include” or “import” |
| | element of the current schema file), all |
| | references to the deleted global element are |
| | replaced with references to a remaining |
| | global element. |
| | b) If no global elements remain, all references |
| | to the deleted element are removed. |
| | c) For each schema element having a |
| | substitution group that is set to the |
| | deleted global element, the substitution |
| | group is reset to be empty. |
| 2. Complex Type | d) Any element having a type of the deleted |
| | complex type is reset to the string type. |
| | e) Any complex type that derives from the |
| | deleted complex type is reset so as to not |
| | be derived. |
| 3. Simple Type | f) Any element having a type of the deleted |
| | simple type is reset to the string type. |
| | g) Any attribute having a type of the deleted |
| | simple type is reset to the string type. |
| | h) Any simple type that derives from the |
| | deleted simple type is reset so as to |
| | instead derive from the string type. |
| 4. Attribute Group | i) If at least one attribute group remains in |
| | the relevant complex type, all references to |
| | the deleted attribute group are replaced |
| | with references to a remaining attribute |
| | group. |
| | j) If no attribute groups remain, all |
| | references to the deleted attribute group |
| | are removed. |
| 5. Group | k) If at least one group remains in the |
| | relevant complex type, all references to the |
| | deleted group are replaced with references |
| | to a remaining group. |
| | l) If no groups remain, all references to the |
| | deleted group are removed. |
| 6. Include | If the deleted include file defines/declares |
| | any of the XML schema objects described above, |
| | the associated referential integrity processing |
| | will occur for each such object. |
| 7. Import | If the deleted import file defines/declares any |
| | of the XML schema object described above, the |
| | associated referential integrity processing |
| | will occur for each such object. |

The core editor software 40 further includes various features pertaining to the input and output of XML schemas. For example, the core editor software 40 is capable of loading an XML schema comprising an ASCII XML source code file from non-volatile memory 26 into the editor 10 and displaying it in the form of a content model 210. Conversely, the software 40 is capable of writing a displayed XML schema to non-volatile memory 26 in the form of ASCII XML source code, ASCII Document Type Definition (DTD) source code, or Java™ code which implements the schema.

The above features are facilitated by the operative object-oriented XML schema object model 300, which will now be described.

XML Schema Object Model

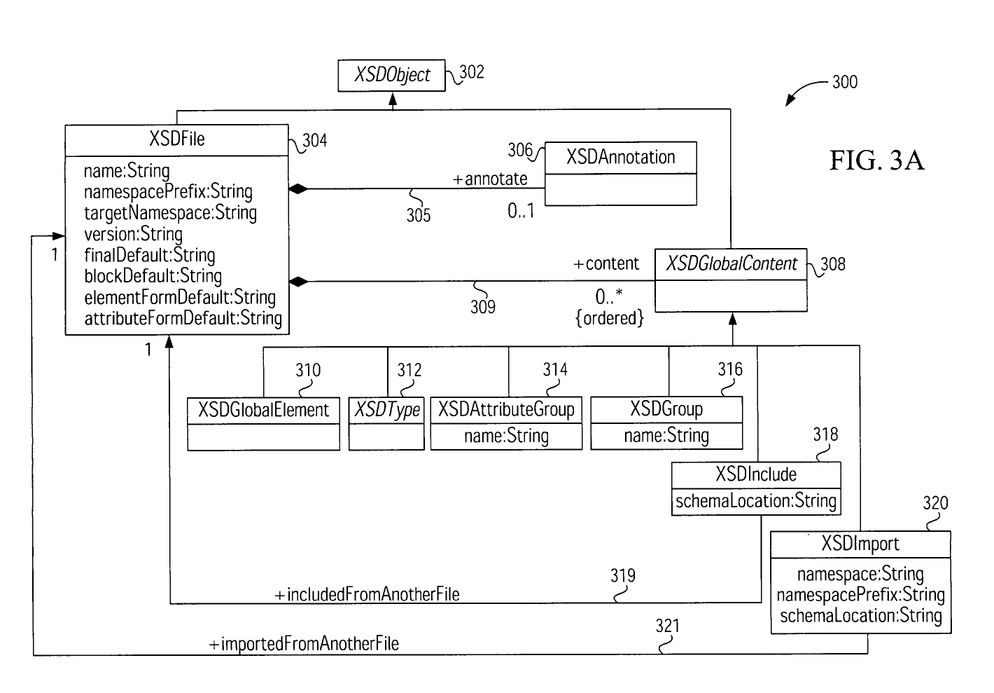

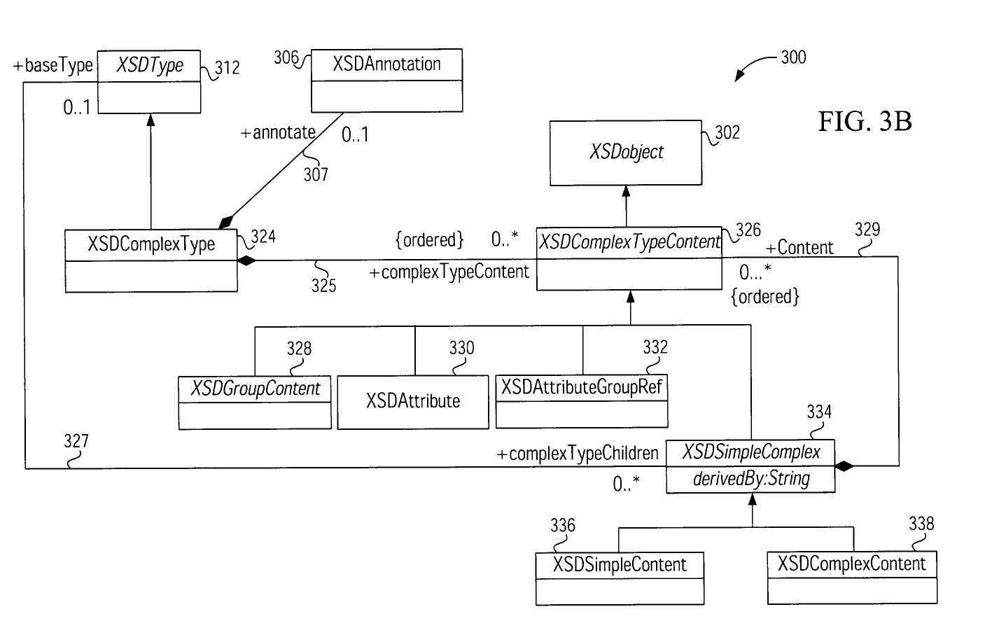

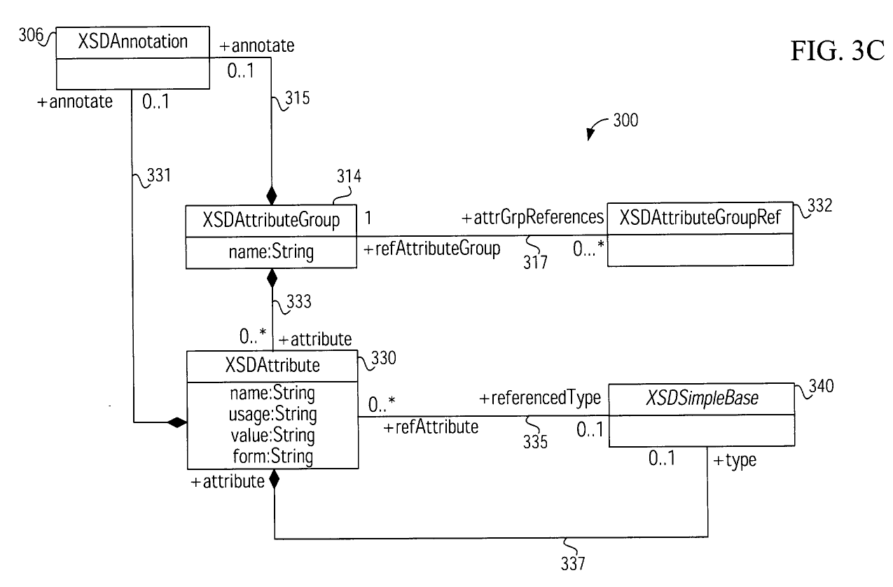

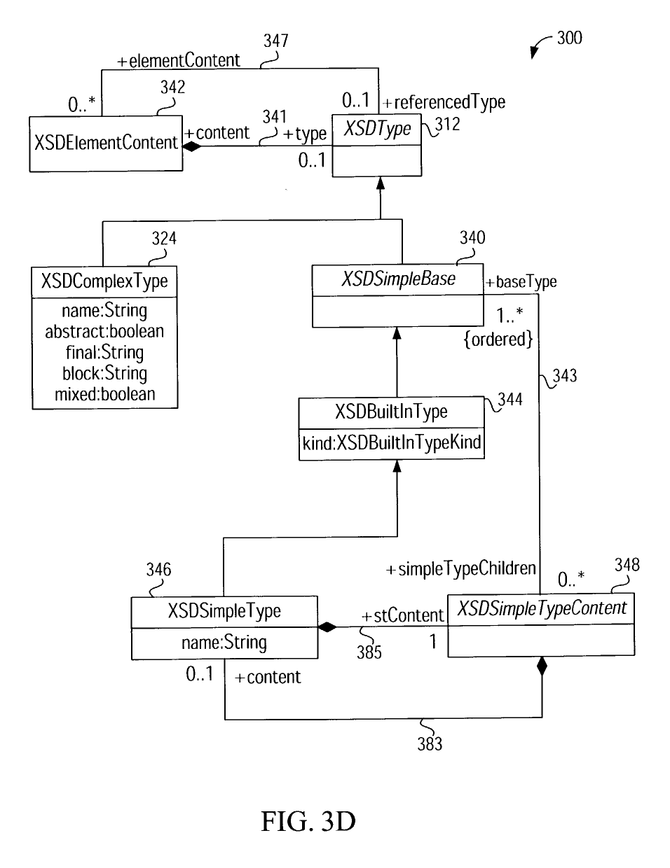

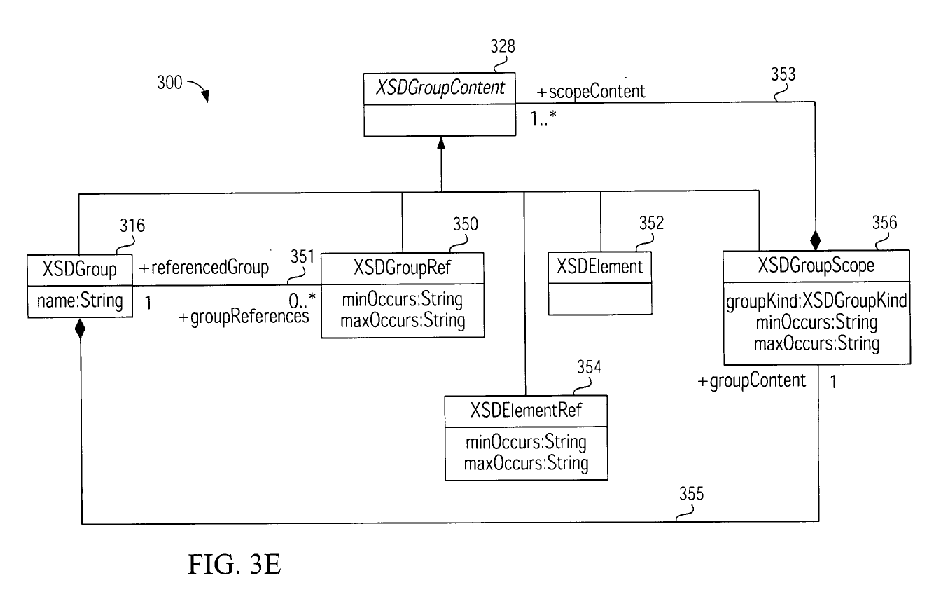

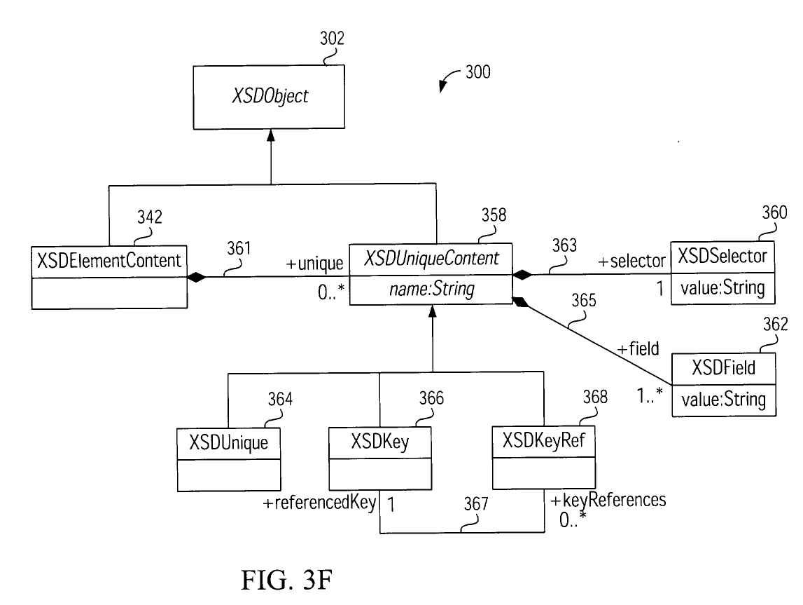

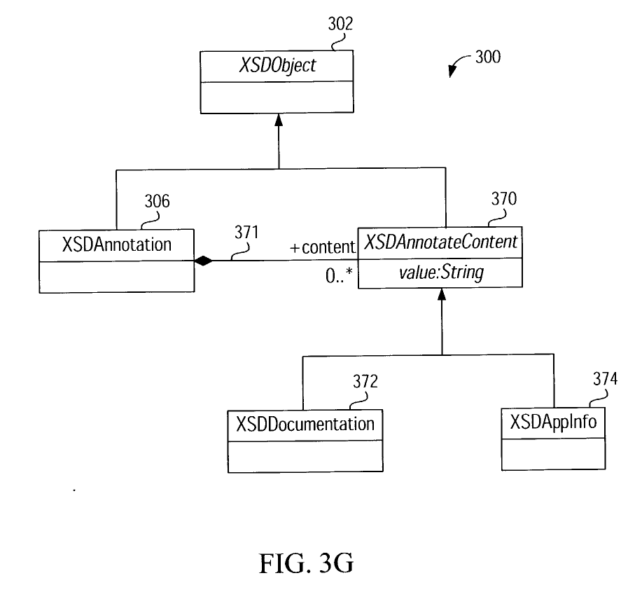

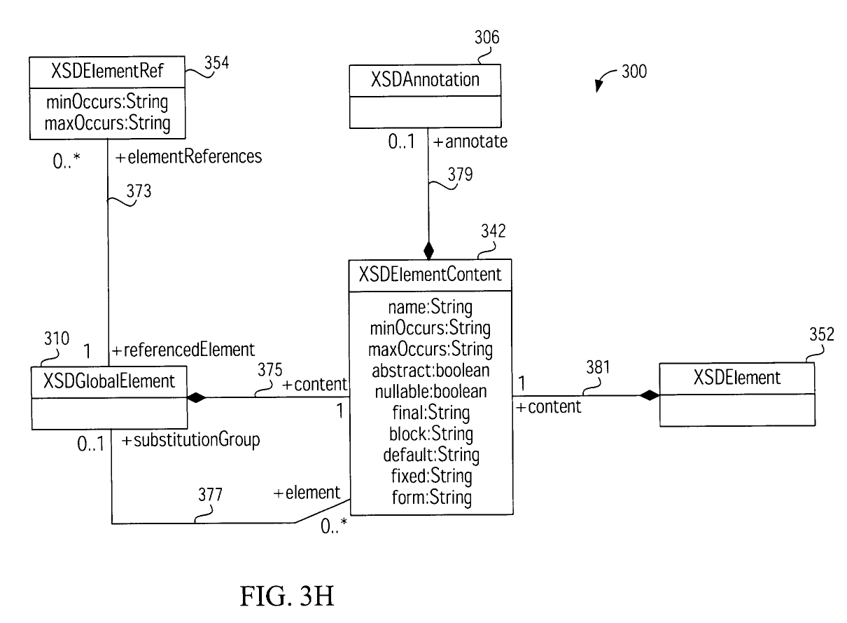

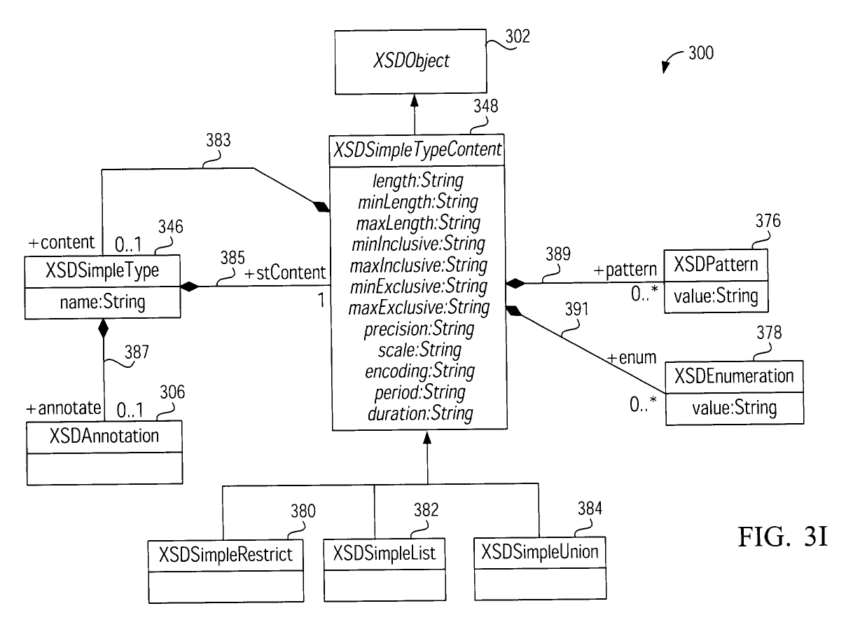

FIGS. 3A-3I comprise a Unified Modeling Language (UML) representation of an XML schema object model 300 according to the present invention. It is this XML schema object model 300 which is implemented by way of the software 42 described previously.

It will be appreciated that a fundamental understanding of UML is necessary in order to best comprehend the model 300. In the event that such an understanding is incomplete, the reader is referred to the text by M. Fowler and K. Scott entitled UML Distilled: A Brief Guide to the Standard Object Modeling Language, 2nd ed., Addison-Wesley, 2000, for clarification, which text is hereby included by reference herein.

The XML schema object model 300 comprises thirty-two concrete object classes and nine abstract base classes. The distinction between concrete classes and abstract base classes is that concrete classes are capable of being instantiated by the software 46 while abstract base classes are not capable of such instantiation. Another distinction in the present case is that concrete classes represent actual XML schema components (i.e. elements or attributes) while abstract base classes may represent categories of components (e.g. a category including either simple types or complex types). Concrete classes may be implemented in the form of “standard” classes of an object-oriented programming language such as Java™ or C++, while abstract base classes may be implemented as “abstract” classes in these languages. It will be appreciated that, pursuant to UML conventions, concrete object classes of the model 300 are identifiable by the use of non-italicized text in their class name in the FIGS. 3A-3I, while the abstract base classes are identifiable by their italicized class names.

It will be understood that the suitability of the model 300 to the task of visualization and construction of XML schemas is due to the set concrete classes and abstract base classes that are defined the model, as well as the interrelationships between those classes. Objects that are created from these classes at run time (to individually represent various XML schema components and cumulatively represent the XML schema as a whole) will form an object tree 44 which, by virtue of the design of the model 300, will be easily and logically navigable at run time to effect the type of processing that is inherent in XML schema visualization and construction.

The hierarchy of the model 300 includes broad classes (e.g. classes descriptive of categories comprising multiple XML components, such as the category “global objects”) as well as more specific classes (e.g. classes descriptive of a single XML schema component, such as an annotation element or simple type definition). Broad classes, which are generally higher in the model hierarchy, may provide advantages in the form of code efficiency due to the benefits of inheritance, as will be understood by those skilled in the art. Moreover, broad classes can be used to support XML schema processing which is “generic” in nature, that is, processing which should be performed with respect to all members of a category of XML schema components (e.g. code which should be executed to display a global XML schema entity icon, regardless of the entity's exact type). In contrast, specific classes can support XML schema processing which is narrower in scope, i.e. processing which should be performed to only for specific types of XML schema component objects (e.g. logic which should be executed to display an annotation element, but is unsuitable for displaying any other type of XML schema entity).

It will be understood that the programming language in which the model is implemented or “realized” should have two capabilities to support the above-described type of processing:

(1) The type of an instantiated object is determinable at run time. The capability to dynamically determine an object's type (e.g. by way of the “instanceof” command in Java™) permits an object's membership in any type of class, whether broad or specific, concrete or abstract, to be determined at run time. When membership in a specific class is determined at run time, this determination may provide information about an object which can be used to trigger specific processing (e.g. if a “vehicle” object is an instance of the class “truck”, then execute a branch of code that prints a map showing only truck routes in a particular city). When membership in a broader class is determined at run time, this determination may provide information about an object which can be used to trigger more generic processing (e.g. if an object is an instance of the class “vehicle”, then, regardless of whether the object's specific class is “car” or “truck”, execute a branch of code that prints a road map of the city).

(2) Objects instantiated from a UML model's classes are able to access their “children” objects and “associated” objects easily and efficiently at run time. Assuming that the interrelationships of a UML model are such that “adjacent” objects (i.e. associated objects) are logically related to one another (which is in fact the case in the model 300), the capacity to easily and efficiently access children and associated objects at run time facilitates quick and logical access to objects that are logically related to a current object.

With respect to conventions used in FIGS. 3A-3I, it will be understood that a class may appear in multiple figures. In this case, each occurrence of the class does not represent a separate class, but rather is a single class which has been included in multiple figures in order to reduce the model's complexity and to promote divisibility of the UML model across multiple pages. As a result, all occurrences of a class in the figures should be viewed for a complete understanding of the interrelationship of the class with its adjacent classes.

It will be observed that none of the object classes defined in the UML model of FIGS. 3A-3I includes a “methods” section. This absence should not be interpreted to mean that none of the classes has any methods. On the contrary, both concrete object classes and abstract object classes may include any number of methods. Indeed, all object classes in the present UML model which contain attributes will be understood to have a pair of “get” and “set” methods for each attribute. These methods (omitted in the figures for brevity) may be executed at run time during, e.g., the display of an XML schema component object's attributes in design pane 206 (“get” attribute) or when those values are changed during XML schema editing (“set” attribute). Also, it will be understood that attributes in addition to those illustrated may be exist within the various classes comprising the model. In fact, it is possible to add whole new classes to the existing XML schema object model without detracting from its utility.

The XML schema object model classes in the UML model of FIGS. 3A-3I will now be described in alphabetical order. The description of each class will include identification of whether or not the class is an abstract class, any superclass(es) of the class, any subclass(es) of the class, and any associations of the class with other classes. It will be noted that, in describing the associations of the class with other classes, the term “My Role” will be used to refer to the UML rolename closest to the class being described, while the term “Other Role” will refer to the rolename closest to the associated class. A brief description of the purpose of each class will also be provided.

1. XSDAnnotateContent Class

| | |
|---|---|
| Abstract | Yes |
| Superclasses | XSDObject |
| Subclasses | XSDDocumentation; XSDAppInfo |

Associations:

| Class | Association Type | My Role | Other Role |
|---|---|---|---|
| XSDAnnotation | composition | content | <none> |

The XSDAnnotateContent class 370 (FIG. 3G) is an abstract base class representative of the content of an annotation element of an XML schema (i.e. it abstractly represents objects that may be contained by an annotation element, such as documentation elements and appInfo elements). The rationale for the existence of the XSDAnnotateContent class 370 in the model 300 is to facilitate processing which is common to both documentation elements and appInfo elements, e.g.:

IF (object = instanceof XSDAnnotateContent)

THEN /* perform processing common to both documentation

and appInfo elements */

This type of processing may occur in the context of generating an output ASCII XML schema file from a displayed XML schema, for example, in which case the processing that occurs in the “THEN” branch may include a series of conditional code branches (e.g. if-then-else statements or a case statement) which only apply to objects which are either a documentation element or an appInfo element. Thus, the processing steps required to perform the comparisons inherent in these code branches may be circumvented for objects that are not containable by an annotation element.

2. XSDAnnotation Class

| | |
|---|---|
| Abstract | No |
| Superclasses | XSDObject |
| Subclasses | <none> |

Associations:

| Class | Association Type | My Role | Other Role |
|---|---|---|---|
| XSDFile | composition | annotate | <none> |
| XSDComplexType | composition | annotate | <none> |
| XSDAttributeGroup | composition | annotate | <none> |
| XSDAttribute | composition | annotate | <none> |
| XSDAnnotateContent | composition | <none> | content |
| XSDElementContent | composition | annotate | <none> |
| XSDSimpleType | composition | annotate | <none> |

The XSDAnnotation class 306 (FIGS. 3A, 3B, 3C, 3G, 3H, and 3I) represents an annotation element of an XML schema. During operation of the XML schema editor 10, an implementation of the XSDAnnotation class 306 is instantiated for each annotation element contained in a displayed XML schema. An annotation object instantiated from the class 306 may be contained by an XML schema file object (by way of composition relationship 305 of FIG. 3A), a complex type object (by way of composition relationship 307 of FIG. 3B), an attribute group object (by way of composition relationship 315 of FIG. 3C), an attribute object (by way of composition relationship 331 of FIG. 3C), a global or non-global element object (by way of composition relationship 379 of FIG. 3H) or a simple type definition object (by way of composition relationship 387 of FIG. 3I). Moreover, the class 306 may have content in the form of one or more documentation objects or appInfo objects by way of composition relationship 371 (FIG. 3G).

3. XSDAppInfo Class

| | |
|---|---|
| Abstract | No |
| Superclasses | XSDAnnotateContent |
| Subclasses | <none> |
| Associations | <none> |

The XSDAppInfo class 374 (FIG. 3G) represents an appInfo element of an XML schema. During operation of the XML schema editor 10, an implementation of the XSDAppInfo class 374 is instantiated for each appInfo element contained in a displayed XML schema. An appInfo object instantiated from the class 374 may be contained by an annotation object by way of composition relationship 371 (FIG. 3G) and is typically used to store information for tools, stylesheets and other applications.

4. XSDAttribute Class

| | |
|---|---|
| Abstract | No |
| Superclasses | XSDComplexTypeContent |
| Subclasses | <none> |

Associations:

| Class | Association Type | My Role | Other Role |
|---|---|---|---|
| XSDAttributeGroup | composition | attribute | <none> |
| XSDAnnotation | composition | <none> | annotate |
| XSDSimpleBase | composition | attribute | type |
| XSDSimpleBase | bi-directional | refAttribute | referencedType |
| | association | | |

The XSDAttribute class 330 (FIGS. 3B and 3C) represents an attribute element of an XML schema. Attribute elements are associated with complex type definitions (but not with simple type definitions). During operation of the XML schema editor 10, an implementation of the XSDAttribute class 330 is instantiated for each attribute element contained in a displayed XML schema. An attribute object instantiated from the class 330 may be contained by an attribute group object (by way of composition relationship 333 of FIG. 3C), may contain an annotation object (by way of composition relationship 331 of FIG. 3C), and may contain/reference a simple or built-in type (by way of composition relationship 337 and bi-directional association relationship 335 of FIG. 3C).

5. XSDAttributeGroup Class

| | |
|---|---|
| Abstract | No |
| Superclasses | XSDGlobalContent |
| Subclasses | <none> |

Associations:

| Class | Association Type | My Role | Other Role |
|---|---|---|---|
| XSDAnnotation | composition | <none> | annotate |
| XSDAttributeGroupRef | bi-directional association | refAttributeGroup | attrGrpReferences |
| XSDAttribute | composition | <none> | attribute |

The XSDAttributeGroup class 314 (FIGS. 3A and 3C) represents an attribute group element of an XML schema. An attribute group is a globally-defined grouping of attributes capable of being referenced from within multiple definitions and declarations in an XML schema. Attribute groups are typically used to improve schema modularity and maintainability. During operation of the XML schema editor 10, an implementation of the XSDAttributeGroup class 314 is instantiated for each attribute group contained in a displayed XML schema. An attribute group object instantiated from the class 314 may contain an annotation object (by way of composition relationship 315 of FIG. 3C) or any number of attribute objects (by way of composition relationship 333 of FIG. 3C), and may be associated with an attribute group reference object (by way of bi-directional association relationship 317 of FIG. 3C).

6. XSDAttributeGroupRef Class

| | |
|---|---|
| Abstract | No |
| Superclasses | XSDComplexTypeContent |
| Subclasses | <none> |

Associations:

| Class | Association Type | My Role | Other Role |
|---|---|---|---|
| XSDAttributeGroup | bi-directional | attrGrpReferences | refAttributeGroup |
| | association | | |

The XSDAttributeGroupRef class 332 (FIGS. 3B and 3C) represents a reference to an attribute group of an XML schema. During operation of the XML schema editor 10, an implementation of the XSDAttributeGroupRef class 332 is instantiated for each attribute group reference contained in a displayed XML schema. An attribute group reference object instantiated from the class 332 will be associated with an attribute group object (described above) by way of bi-directional association relationship 317 (FIG. 3C).

7. XSDBuiltInType Class

| | |
|---|---|
| Abstract | No |
| Superclasses | XSDSimpleBase |
| Subclasses | XSDSimpleType |
| Associations | <none> |

The XSDBuiltInType class 344 (FIG. 3D) represents an XML schema built-in simple type (e.g. boolean, string, byte, integer, date, etc.). During operation of the XML schema editor 10, an implementation of the XSDBuiltInType class 344 is instantiated for each built-in simple type referenced in a displayed XML schema. The class 344 includes a “kind” attribute which indicates the type of XML schema built-in type that is represented (e.g. boolean, float, date, etc.). A built-in type object instantiated from the class 344 may be associated with an attribute by way of composition relationship 337 or bi-directional association relationship 335 of FIG. 3C. The latter relationship 335 is utilized in the case where an anonymous type, i.e. an unnamed type which is incapable of being referenced by other components, is being modeled. As will be appreciated by those skilled in the art, this is possible because the class 344 is descendent from the XSDSimpleBase abstract base class 340 and thus inherits these interrelationships. Moreover, a built-in type object may also be associated with an element by way of composition relationship 341 or bi-directional association relationship 347 of FIG. 3D (with the latter being utilized in the case where an anonymous type is being modeled). This is possible because the class 344 is also descendent from the XSDType abstract base class 312 and thus inherits its interrelationships as well.

8. XSDComplexContent Class

| | |
|---|---|
| Abstract | No |
| Superclasses | XSDSimpleComplex |
| Subclasses | <none> |
| Associations | <none> |

The XSDComplexContent class 338 (FIG. 3B) represents a complex content element of an XML schema. Complex content elements are used in the context of complex type definitions, for the purpose of extending or restricting a complex type. During operation of the XML schema editor 10, an implementation of the XSDComplexContent class 338 is instantiated for each complex content element contained in a displayed XML schema.

9. XSDComplexType Class

| | |
|---|---|
| Abstract | No |
| Superclasses | XSDType |
| Subclasses | <none> |

Associations:

| | Association | | |
|---|---|---|---|
| Class | Type | My Role | Other Role |
| XSDAnnotation | composition | <none> | annotate |
| XSDComplex- | composition | <none> | complexTypeContent |
| Type-Content | | | |

The XSDComplexType class 324 (FIGS. 3B and 3D) represents a complex type definition of an XML schema. During operation of the XML schema editor 10, an implementation of the XSDComplexType class 324 is instantiated for each complex type definition contained in a displayed XML schema. A complex type definition object instantiated from the class 324 may contain an annotation object by way of composition relationship 307 (FIG. 3B), and may also contain any number of types of “complex type content” by way of composition relationship 325 (FIG. 3B) which may comprise attribute objects, attribute group reference objects, group objects, group reference objects, element reference objects, elements, or group scope objects.

10. XSDComplexTypeContent Class

| | |
|---|---|
| Abstract | Yes |
| Superclasses | XSDObject |
| Subclasses | XSDGroupContent; XSDAttribute; |
| | XSDAttributeGroupRef; XSDSimpleComplex |

Associations:

| | Association | | Other |
|---|---|---|---|
| Class | Type | My Role | Role |
| XSDComplexType | composition | complexTypeContent | <none> |
| XSDSimpleComplex | composition | content | <none> |

The XSDComplexTypeContent class 326 (FIG. 3B) is an abstract base class representative of the content of a complex type definition of an XML schema (i.e. it abstractly represents objects that may be contained by a complex type definition). Objects which are descendent from the class 326 (and thus constitute types that may be contained by a complex type definition) include attribute objects, attribute group reference objects, simple content objects, and complex content objects. The rationale for the existence of the XSDComplexTypeContent class 326 in the model 300 is to facilitate processing which is common to all types of objects that may be contained by a complex type definition, e.g.:

IF (object = instanceof XSDComplexTypeContent)

THEN /* perform processing common to all types of

objects that

may be contained by a complex type definition */

This type of processing may occur in the context of generating an output ASCII XML schema file from a displayed XML schema, for example, in which case the processing that occurs in the “THEN” branch may include a series of conditional code branches which only apply to objects that may be contained by a complex type definition. Thus, the processing steps required to perform the comparisons inherent in these code branches may be circumvented for objects that are not containable by a complex type definition.

11. XSDDocumentation Class

| | |
|---|---|
| Abstract | No |
| Superclasses | XSDAnnotateContent |
| Subclasses | <none> |
| Associations | <none> |

The XSDDocumentation class 372 (FIG. 3G) represents a documentation component of an XML schema. A documentation object is typically used to store human readable material. During operation of the XML schema editor 10, an implementation of the XSDDocumentation class 372 is instantiated for each documentation element contained in a displayed XML schema. A documentation object instantiated from the class 372 may be contained by an annotation object by way of composition relationship 371 (FIG. 3G).

12. XSDElement Class

| | |
|---|---|
| Abstract | No |
| Superclasses | XSDGroupContent |
| Subclasses | <none> |

Associations:

| Class | Association Type | My Role | Other Role |
|---|---|---|---|
| XSDElementContent | composition | <none> | content |

The XSDElement class 352 (FIGS. 3E and 3H) represents a non-global element of an XML schema which may be declared in the context of a complex type definition. Global elements are represented as a separate class from non-global elements in order to facilitate processing in which global elements and non-global elements are treated differently (e.g. during the generation of a list of global elements from which a user may select one entry as the element to which an element reference object should refer). During operation of the XML schema editor 10, an implementation of the XSDElement class 352 is instantiated for each non-global element contained in a displayed XML schema. An element object instantiated from the class 352 will have content in the form of an “element content” object contained by way of composition relationship 381 (FIG. 3H) and may be contained by a group object by way of composition relationships 341 and 347 (FIG. 3D).

13. XSDElementContent Class

| | |
|---|---|
| Abstract | No |
| Superclasses | XSDObject |
| Subclasses | <none> |

Associations:

| | Association | | |
|---|---|---|---|
| Class | Type | My Role | Other Role |
| XSDUniqueContent | composition | <none> | unique |
| XSDType | composition | content | type |
| XSDType | bi-directional | element- | referencedType |
| | association | Content | |
| XSDAnnotation | composition | <none> | annotate |
| XSDGlobalElement | composition | content | referencedElement |
| XSDGlobalElement | bi-directional | element | substitutionGroup |
| | association | | |
| XSDElement | composition | content | <none> |

The XSDElementContent class 342 (FIGS. 3D, 3F and 3H) represents an “element content” object of an XML schema, i.e. it represents objects that may be contained by a global or non-global element object. During operation of the XML schema editor 10, an implementation of the XSDElementContent class 342 is instantiated for each global or non-global element contained in a displayed XML schema. An element content object instantiated from the class 342 will be contained by either a global element object or a non-global element object by way of composition relationship 375 and 381, respectively, of FIG. 3H. The element content object may further be associated with a global element object by way of bi-directional association relationship 377 (FIG. 3H), which may be used to identify a global element which is substitutable with that element. The class 342 includes a “name” attribute, which is a string comprising the name of the containing element, in addition to various other attributes. The element content object is optionally associated with (i.e. refers to or contains by way of bi-directional association relationship 347 and composition relationship 341, respectively, of FIG. 3D) a type object, which may be a complex or simple type. Moreover, an element content object may contain an annotation object by way of composition relationship 379 (FIG. 3H) as well as any number of “unique” objects, key objects and key reference objects by way of composition relationship 361 (FIG. 3F).

14. XSDElementRef Class

| | |
|---|---|
| Abstract | No |
| Superclasses | XSDGroupContent |
| Subclasses | <none> |

Associations:

| Class | Association Type | My Role | Other Role |
|---|---|---|---|
| XSDGlobal- | bi-directional | element- | referencedElement |
| Element | association | References | |

The XSDElementRef class 354 (FIGS. 3E and 3H) represents a reference to a global element of an XML schema. Element references are a construct of XML schemas by which an additional instance of a previously-defined global element may be easily declared. During operation of the XML schema editor 10, an implementation of the XSDElementRef class 354 is instantiated for each element reference contained in a displayed XML schema. An element reference object instantiated from the class 354 will be associated with a global element object (described below) by way of bi-directional association relationship 373 (FIG. 3H).

15. XSDEnumeration Class

| | |
|---|---|
| Abstract | No |
| Superclasses | <none> |
| Subclasses | <none> |

Associations:

| Class | Association Type | My Role | Other Role |
|---|---|---|---|
| XSDSimpleTypeCon- | composition | enum | <none> |
| tent | | | |

The XSDEnumeration class 378 (FIG. 3I) represents an enumeration facet of an XML schema. Enumeration facets may be used in XML schemas to constrain the values of simple types definitions (except for boolean values). During operation of the XML schema editor 10, an implementation of the XSDEnumeration class 378 is instantiated for each enumeration facet contained in a displayed XML schema. Any number of enumeration facet objects may be contained by a list type object, a simple type restriction object, or a union type object by way of composition relationship 391 (FIG. 3I).

16. XSDField Class

| | |
|---|---|
| Abstract | No |
| Superclasses | <none> |
| Subclasses | <none> |

Associations:

| Class | Association Type | My Role | Other Role |
|---|---|---|---|
| XSDUniqueContent | composition | field | <none> |

The XSDField class 362 (FIG. 3F) represents an XML schema field element. Field elements are used in conjunction with selector elements to identify attributes or elements within a selected set of elements which must be unique within the set. During operation of the XML schema editor 10, an implementation of the XSDField class 362 is instantiated for each field element contained in a displayed XML schema. A “unique” object, a key object, or a key reference object will contain at least one field element object by way of composition relationship 365 (FIG. 3F).

17. XSDFile Class

| | |
|---|---|
| Abstract | No |
| Superclasses | XSDObject |
| Subclasses | <none> |

Associations:

| Class | Association Type | My Role | Other Role |
|---|---|---|---|
| XSDAnnotation | composition | <none> | annotate |
| XSDGlobalContent | composition | <none> | content |
| XSDInclude | uni-directional | includedFrom- | <none> |
| | association | Another-File | |
| XSDImport | uni-directional | importedFrom- | <none> |
| | association | Another-File | |

The XSDFile class 304 (FIG. 3A) represents a single file containing at least part of an XML schema definition. The XSDFile class effectively allows an XML schema to be modularized on a file by file basis. During operation of the XML schema editor 10, a single implementation of the XSDFile class 304 will be instantiated for the displayed XML schema file, and an additional XSDFile class object will be instantiated for each file referenced from within that file by way of an include or import element. Thus, in combination with the XSDInclude and XSDImport classes (described below), the XSDFile class 304 allows an XML schema to be conveniently represented in the form of multiple files, possibly in different namespaces. A file object instantiated from class 304 may contain an annotation object (by way of composition relationship 305 of FIG. 3A) as well as any number of instances of “global content” (by way of composition relationship 309 of FIG. 3A), including global elements, complex type definitions, simple type definitions, attribute groups, groups, include elements and import elements.

18. XSDGlobalContent Class

| | |
|---|---|
| Abstract | Yes |
| Superclasses | XSDObject |
| Subclasses | XSDGlobalElement, XSDType, XSDAttributeGroup, |
| | XSDGroup, XSDInclude, XSDImport. |
| Associations | <none> |

The XSDGlobalContent class 308 (FIG. 3A) is an abstract base class representative of the global content of an XML schema file. The class 308 represents objects that may be contained in an XML schema file at a global level, such as global elements, complex type definitions, simple type definitions, attribute groups, groups, include elements and import elements. XML schema elements descendent from this class represent elements which may exist at a “global” level within the schema. The rationale for the existence of class 308 is to facilitate the processing of an XML schema file's global objects, for such purposes as generating a list of selectable user-defined types or global elements, for example. This may be achieved by way of a loop, which may be as follows:

FOR each direct “content” object descendent of the current
XSDFile object:
{

IF content = instance of <desired class type>

(take a particular action, e.g., add the name of the
object to a list).

}

This type of processing may occur in the context of generating an output ASCII XML schema file from a displayed XML schema, for example, in which case the processing that occurs in the “THEN” branch may include a series of conditional code branches which only apply to objects that may be contained in an XML schema file at a global level. Thus, the processing steps required to perform the comparisons inherent in these code branches may be circumvented for objects that are not containable in an XML schema file at a global level.

19. XSDGlobalElement Class

| | |
|---|---|
| Abstract | No |
| Superclasses | XSDGlobalContent |
| Subclasses | <none> |

Associations:

| Class | Association Type | My Role | Other Role |
|---|---|---|---|
| XSDElementContent | composition | <none> | content |
| XSDElementContent | bi-directional | substitu- | element |
| | association | tionGroup | |
| XSDElementRef | composition | referenced- | element- |
| | | Element | References |

The XSDGlobalElement class 310 (FIGS. 3A and 3H) represents a global element of an XML schema. Global elements are represented as a separate class from non-global elements in order to facilitate processing in which global elements and non-global elements are treated differently. Such differentiation between elements of different scopes may occur for example during the generation of a list of global elements (from either the current XML schema file or from an imported or included XML schema file) from which a user may select one entry as the element to which an element reference object should refer. During operation of the XML schema editor 10, an implementation of the XSDGlobalElement class 310 is instantiated for each global element contained in a displayed XML schema. A global element object instantiated from the class 310 will have content in the form of an “element content” object contained by way of composition relationship 375 of FIG. 3H. As well, a global element object may be associated with any number of element reference objects by way of bi-directional association relationship 373 of FIG. 3H.

20. XSDGroup Class

| | |
|---|---|
| Abstract | No |
| Superclasses | XSDGlobalContent, XSDGroupContent |
| Subclasses | <none> |

Associations:

| Class | Association Type | My Role | Other Role |
|---|---|---|---|
| XSDGroupScope | composition | <none> | groupContent |
| XSDGroupRef | bi-directional | referenced- | groupReferences |
| | association | Group | |

The XSDGroup class 316 (FIGS. 3A and 3E) represents a named group of elements of an XML schema that is associated with a content model of a complex type definition. During operation of the XML schema editor 10, an implementation of the XSDGroup class 316 is instantiated for each such named group of elements contained in a displayed XML schema. A group object instantiated from the class 316 will contain an XSDGroupScope object by way of composition relationship 355 (FIG. 3E) which defines the nature of the grouping (choice, sequence, or all), and may be referred to by a group reference object by way of bi-directional association relationship 351 (FIG. 3E).

21. XSDGroupContent Class

| | |
|---|---|
| Abstract | Yes |
| Superclasses | XSDComplexTypeContent |
| Subclasses | XSDGroup; XSDGroupRef; XSDElementRef; |
| | XSDElement; XSDGroupScope |

Associations:

| Class | Association Type | My Role | Other Role |
|---|---|---|---|
| XSDGroupScope | composition | scopeContent | <none> |

The XSDGroupContent class 328 (FIGS. 3B and 3E) is an abstract base class representative of the group-related content of a complex type definition in an XML schema. That is, the class 328 abstractly represents group-related objects that may be contained in a complex type definition, such as a group element, a group reference element, an element, or an element reference for example. The rationale for the existence of the XSDGroupContent class 328 in the model 300 is to facilitate processing which is common to all types of group-related content of a complex type definition, e.g.:

IF (object = instanceof XSDComplexTypeContent)

THEN /* perform processing that is common to all types

of

group-related content of a complex type definition */

This type of processing may occur in the context of generating an output ASCII XML schema file from a displayed XML schema, for example, in which case the processing that occurs in the “THEN” branch may include a series of conditional code branches which only apply to group-related objects that may be contained by a complex type definition. Thus, the processing steps required to perform the comparisons inherent in these code branches may be circumvented for objects that are not group-related and containable in a complex type definition.

22. XSDGroupRef Class

| | |
|---|---|
| Abstract | No |
| Superclasses | XSDGroupContent |
| Subclasses | <none> |

Associations:

| Class | Association Type | My Role | Other Role |
|---|---|---|---|
| XSDGroup | bi-directional | groupReferences | referencedGroup |
| | association | | |

The XSDGroupRef class 350 (FIG. 3E) represents a reference to a named group of elements in a complex type definition of an XML schema. During operation of the XML schema editor 10, an implementation of the XSDGroupRef class 350 is instantiated for each group reference contained in a displayed XML schema. A group reference object instantiated from the class 350 will be associated with a group object (described above) by way of bi-directional association relationship 351 (FIG. 3E).

23. XSDGroupScope Class

| | |
|---|---|
| Abstract | No |
| Superclasses | XSDGroupContent |
| Subclasses | <none> |

Associations:

| Class | Association Type | My Role | Other Role |
|---|---|---|---|
| XSDGroupContent | composition | <none> | scopeContent |
| XSDGroup | composition | groupContent | <none> |

The XSDGroupScope class 356 (FIG. 3E) defines the nature of the grouping (choice, sequence, or all) of a named group of elements in an XML schema. During operation of the XML schema editor 10, an implementation of the XSDGroupScope class 356 will be instantiated for each declared group in a displayed XML schema. The class 356 includes a “XSDGroupKind” attribute which reflects whether the group is a “choice”, “sequence” or “all” group, as well as “minOccurs” and “maxOccurs” fields which describe the cardinality of the elements. A group scope object instantiated from the class 356 will have content in the form of a group object, a group reference object, an element reference object, an element object or another group scope object by way of composition relationship 353 (FIG. 3E).

24. XSDImport Class

| | |
|---|---|
| Abstract | No |
| Superclasses | XSDGlobalContent |
| Subclasses | <none> |

Associations:

| Class | Association Type | My Role | Other Role |
|---|---|---|---|
| XSDFile | uni-directional | <none> | importedFrom- |
| | association | | Another-File |

The XSDImport class 320 (FIG. 3A) represents an import element of an XML schema file that is used to import another XML schema file from a different namespace into the current XML schema. In conjunction with the XSDFile and XSDInclude classes 304 and 318, the XSDImport class 320 effectively allows an XML schema to be modularized on a file by file basis. During operation of the XML schema editor 10, an implementation of the XSDImport class 320 is instantiated for each XML schema file that is referenced from within the current XML schema file by way of an import element. An import object instantiated from the class 320 will refer to a XML schema file object by way of uni-directional association relationship 321 (FIG. 3A).

25. XSDInclude Class

| | |
|---|---|
| Abstract | No |
| Superclasses | XSDGlobalContent |
| Subclasses | <none> |

Associations:

| Class | Association Type | My Role | Other Role |
|---|---|---|---|
| XSDFile | uni-directional | <none> | includedFrom- |
| | association | | Another-File |

The XSDInclude class 318 (FIG. 3A) represents an include element that is used to include another XML schema file from the same namespace into the current XML schema. In conjunction with the XSDFile and XSDImport classes 304 and 320, the XSDInclude class 318 effectively allows an XML schema to be modularized on a file by file basis. During operation of the XML schema editor 10, an implementation of the XSDInclude class 318 is instantiated for each XML schema file in the same namespace that is referenced from the current XML schema file by way of an include element. An include object instantiated from the class 318 will refer to a XML schema file object by way of uni-directional association relationship 319 (FIG. 3A).

26. XSDKey Class

| | |
|---|---|
| Abstract | No |
| Superclasses | XSDUniqueContent |
| Subclasses | <none> |

Associations:

| Class | Association Type | My Role | Other Role |
|---|---|---|---|
| XSDKeyRef | bi-directional | referencedKey | keyReferences |
| | association | | |

The XSDKey class 366 (FIG. 3F) represents an XML schema key element. Key elements are used to identify an attribute of each of a selected set of elements which must be unique and cannot be set to nil within the set. During operation of the XML schema editor 10, an implementation of the XSDKey class 366 is instantiated for each key element contained in a displayed XML schema. A key object instantiated from the class 366 will contain a selector object by way of composition relationship 363 (FIG. 3F) and at least one field object by way of composition relationship 365 (FIG. 3F), and may be associated with by any number of key reference objects by way of bi-directional association relationship 367 (FIG. 3F).

27. XSDKeyRef Class

| | |
|---|---|
| Abstract | No |
| Superclasses | XSDUniqueContent |
| Subclasses | <none> |

Associations:

| Class | Association Type | My Role | Other Role |
|---|---|---|---|
| XSDKey | bi-directional | keyReferences | referencedKey |
| | association | | |

The XSDKeyRef class 368 (FIG. 3F) represents a reference to a key element of an XML schema. During operation of the XML schema editor 10, an implementation of the XSDKeyRef class 368 is instantiated for each key reference contained in a displayed XML schema. A key reference object instantiated from the class 368 will refer to a key object (described above) by way of bi-directional association relationship 367 (FIG. 3F), and will contain a selector object through composition relationship 363 (FIG. 3F) and at least one field object by way of composition relationship 365 (FIG. 3F).

28. XSDObject Class

| | |
|---|---|
| Abstract | No |
| Superclasses | <none> |
| Subclasses | XSDFile, XSDGlobalContent, XSDComplexTypeCon- |
| | tent, XSDElementContent, XSDUniqueContent, |
| | XSDAnnotation, XSDAnnotateContent, |
| | XSDSimpleTypeContent |
| Associations | <none> |

The XSDObject class 302 (FIGS. 3A, 3B, 3F, 3G and 3I) is the class from which most of the other classes in FIGS. 3A-3I are descendent. The rationale for the existence of the XSDObject class 302 in the model 300 is to allow the definition of attributes (i.e. XSDObject class attributes, to be distinguished from XML schema element attributes) and methods that are applicable to all XML schema elements descendent from the XSDObject class, so that these attributes and methods may be inherited by these descendent elements.

For example, an implementation of the XSDObject class 302 may include attributes and methods which pertain to an XML schema editor objective, such as the promotion of XML schema comprehension through the use of certain XML schema editor display techniques, that is applicable to most of the types of objects defined in the model 300. For instance, in the case of the present XML schema editor 10, attributes and methods are defined that are used to facilitate the highlighting of XML source code in the source code pane 206 which corresponds with a selected XML schema icon. Other applications may be employed in different XML schema editor embodiments.

29. XSDPattern Class

| | |
|---|---|
| Abstract | No |
| Superclasses | <none> |
| Subclasses | <none> |

Associations:

| Class | Association Type | My Role | Other Role |
|---|---|---|---|
| XSDSimpleTypeCon- | composition | pattern | <none> |
| tent | | | |

The XSDPattern class 376 (FIG. 3I) represents a pattern facet of an XML schema. Pattern facets may be used in XML schemas to constrain the values of simple types definitions to certain patterns, e.g. three digits followed by a hyphen followed by two upper-case ASCII letters. During operation of the XML schema editor 10, an implementation of the XSDPattern class 376 is instantiated for each pattern facet contained in a displayed XML schema. Any number of pattern facet objects may be contained by a list type object, a simple type restriction object, or a union type object by way of composition relationship 389 (FIG. 3I).

30. XSDSelector Class

| | |
|---|---|
| Abstract | No |
| Superclasses | <none> |
| Subclasses | <none> |

Associations:

| Class | Association Type | My Role | Other Role |
|---|---|---|---|
| XSDUniqueContent | composition | selector | <none> |

The XSDSelector class 360 (FIG. 3F) represents an XML schema selector element. Selector elements are used in conjunction with the field elements to select a set of elements containing an attribute or element whose value must be unique within the set. During operation of the XML schema editor 10, an implementation of the XSDSelector class 360 is instantiated for each selector element contained in a displayed XML schema. A “unique” object, a key object, or a key reference object will each contain a selector element object by way of composition relationship 363 (FIG. 3F).

31. XSDSimpleBase Class

| | |
|---|---|
| Abstract | Yes |
| Superclasses | XSDType |
| Subclasses | XSDBuiltInType |

Associations:

| Class | Association Type | My Role | Other Role |
|---|---|---|---|
| XSDAttribute | composition | type | attribute |
| XSDAttribute | bi-directional | referencedType | refAttribute |
| | association | | |
| XSDSimpleType- | bi-directional | baseType | simpleType- |
| Content | association | | Children |

The XSDSimpleBase class 340 (FIGS. 3C and 3D) is an abstract base class representative of simple types and built-in XML schema types (which are a subset of simple types). Descendents of the XSDSimpleBase class 340 include the XSDBuiltInType and XSDSimpleType classes 344 and 346. The rationale for the existence of the XSDSimpleBase class 340 in the model 300 is to facilitate processing which is common to simple types and built-in XML schema types, e.g.:

IF (object = instanceof XSDSimpleBase)

THEN /* perform processing that is common to simple

types

and built-in types*/

This type of processing may occur in the context of generating an output ASCII XML schema file from a displayed XML schema, for example, in which case the processing that occurs in the “THEN” branch may include a series of conditional code branches which only apply to objects that are either simple types or built-in XML schema types. Thus, the processing steps required to perform the comparisons inherent in these code branches may be circumvented for objects that are not simple types or built-in types.

Objects descended from the class 340 may be contained by or associated with an attribute object by way of composition relationship 337 and bi-directional association relationship 335, respectively, of FIG. 3C, and may be associated with an object descended from the XSDSimpleTypeContent class 348 by way of bi-directional association relationship 343 (FIG. 3D). The purpose of relationship 343 is to model the parent of a simple type, when a simple type extends another simple type to add further constraints for example.

32. XSDSimpleComplex Class

| | |
|---|---|
| Abstract | Yes |
| Superclasses | XSDComplexTypeContent |
| Subclasses | XSDSimpleContent; XSDComplexContent |

Associations:

| Class | Association Type | My Role | Other Role |
|---|---|---|---|
| | composition | | |
| XSDComplexType- | composition | <none> | content |
| Content | | | |
| XSDType | bi-directional | complexType- | baseType |
| | association | Children | |

The XSDSimpleComplex class 334 (FIG. 3B) is an abstract base class representative of simple or complex type content in a complex type definition of an XML schema. Descendents of the XSDSimpleComplex class 334 comprise the XSDSimpleContent and XSDComplexContent classes 336 and 338. The rationale for the existence of the XSDSimpleComplex class 334 in the model 300 is to facilitate processing which is common to both simple or complex type content in a complex type definition, e.g.:

IF (object=instanceof XSDSimpleComplex)

THEN /* perform processing that is common to both simple type content

or complex type content of a complex type definition */

This type of processing may occur in the context of generating an output ASCII XML schema file from a displayed XML schema, for example, in which case the processing that occurs in the “THEN” branch may include code which outputs aspects of the object which are common to both a simple type and a complex type (e.g. the object's “name” attribute).

33. XSDSimpleContent Class

| | |
|---|---|
| Abstract | No |
| Superclasses | XSDSimpleComplex |
| Subclasses | <none> |
| Associations | <none> |

The XSDSimpleContent class 336 (FIG. 3B) represents a simple content element of an XML schema. Simple content elements are used in the context of complex type definitions, to indicate that the content model of the complex type contains only character data and no elements. During operation of the XML schema editor 10, an implementation of the XSDSimpleContent class 336 is instantiated for each complex content element contained in a displayed XML schema.

34. XSDSimpleList Class

| | |
|---|---|
| Abstract | No |
| Superclasses | XSDSimpleTypeContent t |
| Subclasses | <none> |
| Associations | <none> |

The XSDSimpleList class 382 (FIG. 3I) represents a list element of an XML schema. List elements are used to create new list types comprising a sequence of simple type objects. During operation of the XML schema editor 10, an implementation of the XSDSimpleList class 382 is instantiated for each list element contained in a displayed XML schema. A list object instantiated from the class 382 may contain a pattern facet by way of composition relationship 389 (FIG. 3I) or an enumeration facet by way of composition relationship 391 (FIG. 3I).

35. XSDSimpleRestrict Class

| | |
|---|---|
| Abstract | No |
| Superclasses | XSDSimpleTypeContent |
| Subclasses | <none> |
| Associations | <none> |

XSDSimpleRestrict class 380 (FIG. 3I) represents a restriction element of an XML schema. Restriction elements are used to create new types based on simple types having a legal range of values that is a subset of the simple type's legal range of values. During operation of the XML schema editor 10, an implementation of the XSDSimpleRestrict class 380 is instantiated for each restriction element contained in a displayed XML schema. A simple type restriction object instantiated from the class 380 may contain a pattern facet by way of composition relationship 389 (FIG. 3I) or an enumeration facet by way of composition relationship 391 (FIG. 3I).

36. XSDSimpleType Class

| | |
|---|---|
| Abstract | No |
| Superclasses | XSDBuiltInType |
| Subclasses | <none> |

Associations:

| Class | Association Type | My Role | Other Role |
|---|---|---|---|
| XSDSimpleType-Con- | composition | <none> | stContent |
| tent | | | |
| XSDSimpleType-Con- | composition | content | <none> |
| tent | | | |
| XSDAnnotation | composition | <none> | annotate |

The XSDSimpleType class 346 (FIGS. 3D and 3I) represents a simple type definition in an XML schema. During operation of the XML schema editor 10, an implementation of the XSDSimpleType class 346 is instantiated for each simple type definition contained in a displayed XML schema. A simple type definition object instantiated from the class 346 may contain an annotation object by way of composition relationship 387 (FIG. 3I) and any number of types of “simple type content” comprising simple type restriction objects, simple type list objects, and simple type union objects by way of composition relationship 385 (FIG. 3D and FIG. 3I).

37. XSDSimpleTypeContent Class

| | |
|---|---|
| Abstract | Yes |
| Superclasses | XSDObject |
| Subclasses | XSDSimpleRestrict; XSDSimpleList; XSDSimpleUnion |

Associations:

| Class | Association Type | My Role | Other Role |
|---|---|---|---|
| XSDSimpleType | composition | stContent | <none> |
| XSDSimpleType | composition | <none> | content |
| XSDSimpleBase | bi-directional | simpleTypeChildren | baseType |
| | association | | |
| XSDPattern | composition | <none> | pattern |
| XSDEnumeration | composition | <none> | enum |

The XSDSimpleTypeContent class 348 (FIGS. 3D and 3I) is an abstract base class representative of the content of a simple type definition of an XML schema (i.e. it abstractly represents objects that may be contained by a simple type definition). Objects which are descendent from the class 348 include list type objects, simple type restriction objects, and union type objects (represented by classes 380, 382 and 384, respectively, of FIG. 3I). An object instantiated from class 348 can contain a pattern or enumeration facet by way of composition relationships 389 and 391 (respectively) of FIG. 3I, in addition to a simple type object by way of composition relationship 383. It is noted that relationship 383 is “recursive” with relationship 385 in that a first simple type object may contain a simple type content object which may in turn contain a second simple type object, but the first and second simple type objects are understood to be distinct instances of the simple type class. The rationale for the existence of the XSDSimpleTypeContent class 312 in the model 300 is to facilitate processing which is common to all types of content of a simple type definition, e.g.:

IF (object = instanceof XSDSimpleTypeContent)

THEN /* perform processing that is common to all types

of

content of a simple type definition */

38. XSDSimpleUnion Class

| | |
|---|---|
| Abstract | No |
| Superclasses | XSDSimpleTypeContent |
| Subclasses | <none> |
| Associations | <none> |

XSDSimpleUnion class 384 (FIG. 3I) represents a union element of an XML schema. Union elements are used to create new union types comprising one or more instances of one type drawn from the union of multiple simple and list types. During operation of the XML schema editor 10, an implementation of the XSDSimpleUnion class 384 is instantiated for each union element contained in a displayed XML schema. A union object instantiated from the class 384 may contain a pattern facet by way of composition relationship 389 or an enumeration facet by way of composition relationship 391 (both of FIG. 3I).

39. XSDType Class

| | |
|---|---|
| Abstract | Yes |
| Superclasses | XSDGlobalContent |
| Subclasses | XSDComplexType, XSDSimpleBase |

Associations:

| Class | Association Type | My Role | Other Role |
|---|---|---|---|
| XSDAnnotation | composition | <none> | annotate |
| XSDComplexType- | composition | <none> | complexType- |
| Content | | | Content |
| XSDElementContent | composition | type | content |
| XSDElementContent | bi-directional | referenced- | element- |
| | association | Type | Content |

The XSDType class 312 (FIGS. 3A, 3B and 3D) is an abstract base class representative a generic type definition of an XML schema (i.e. it abstractly represents a built-in, simple or complex type definition). Descendents of the XSDType class 312 include the XSDBuiltInType class 344, XSDSimpleType class 346 and XSDComplexType class 324. The rationale for the existence of the XSDType class 312 in the model 300 is to facilitate processing which is common to all XML schema types, e.g.:

IF (object = instanceof XSDType)

THEN /* perform processing that is common to all

XML schema types */

40. XSDUnique Class

| | |
|---|---|
| Abstract | No |
| Superclasses | XSDUniqueContent |
| Subclasses | <none> |
| Associations | <none> |

The XSDUnique class 364 (FIG. 3F) represents an XML schema unique element. Unique elements are used in conjunction with selector elements and field elements for the purpose of selecting a set of elements containing an attribute or element whose value must be unique within the set. During operation of the XML schema editor 10, an implementation of the XSDUnique class 364 is instantiated for each unique element contained in a displayed XML schema.

| 41. XSDUniqueContent Class | |
|---|---|
| Abstract | Yes |
| Superclasses | XSDObject |
| Subclasses | XSDUnique; XSDKey; XSDKeyRef |

Associations:

| Class | Association Type | My Role | Other Role |
|---|---|---|---|
| XSDElementContent | composition | unique | <none> |
| XSDSelector | composition | <none> | selector |
| XSDField | composition | <none> | field |

The XSDUniqueContent class 358 (FIG. 3F) is an abstract base class representative of elements of an XML schema which may be used to indicate that an attribute or element value must be unique within a certain scope. Concrete class descendents of the XSDUniqueContent class 358 (all of FIG. 3F) include the XSDUnique class 364, XSDKey class 366 and XSDKeyRef class 368. The rationale for the existence of the XSDUniqueContent class 358 in the model 300 is to facilitate processing which is common to all types of elements which may be used to indicate that an attribute or element value must be unique within a certain scope, e.g.:

IF (object = instanceof XSDUniqueContent)

THEN /* perform processing that is common to all types

of elements

which may be used to indicate that an attribute or element

value

must be unique within a certain scope */

Operation

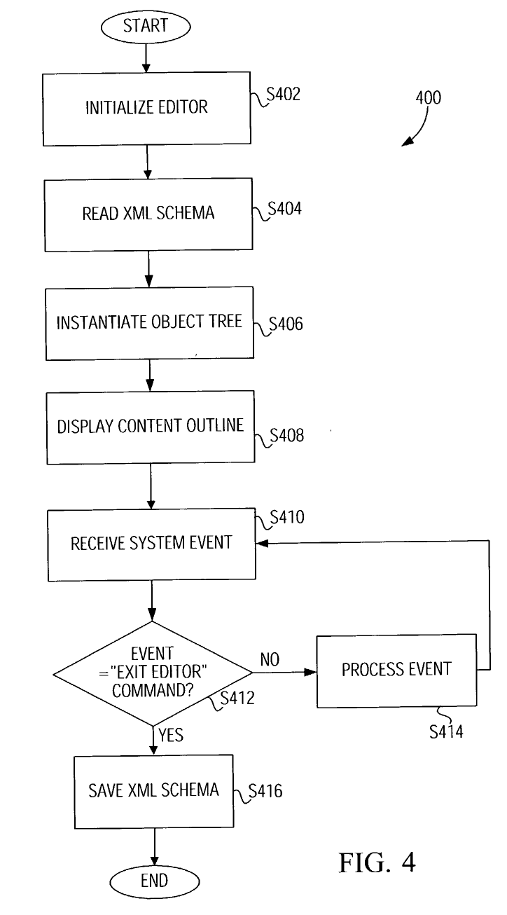

The operation of the present embodiment is illustrated in the flowchart of steps 400 of FIG. 4, with additional reference to FIGS. 1, 2, 3A-3I, 5A, 5B, 5C and 6. In step S402, the XML schema editor 10 is initialized. Step S402 is triggered by invocation of the editor 10 by a user 18. This step involves the execution of initialization code in the core editor software 40 which results in the creation and display of the graphical user interface 200 including the content pane 202, the design pane 204, and various editor menu options for such actions as loading an XML schema from file or saving the current XML schema to file in various forms. As will be understood by those skilled in object-oriented software design, this initialization process of step S402 may include such steps as instantiating various GUI objects (windows, buttons, menus, etc.) and associating “listener” objects with these objects to handle specific events, in a conventional manner.

In step S404 an XML schema is read by the editor 10. Step S404 is triggered by the entering of a “load schema” command into the editor 10 by a user 18 through interaction with the editor menu and the UIM 20. It will be understood that entry of this command and the corresponding reading of an XML schema are optional, as a user may alternatively use the editor to create an XML schema afresh.

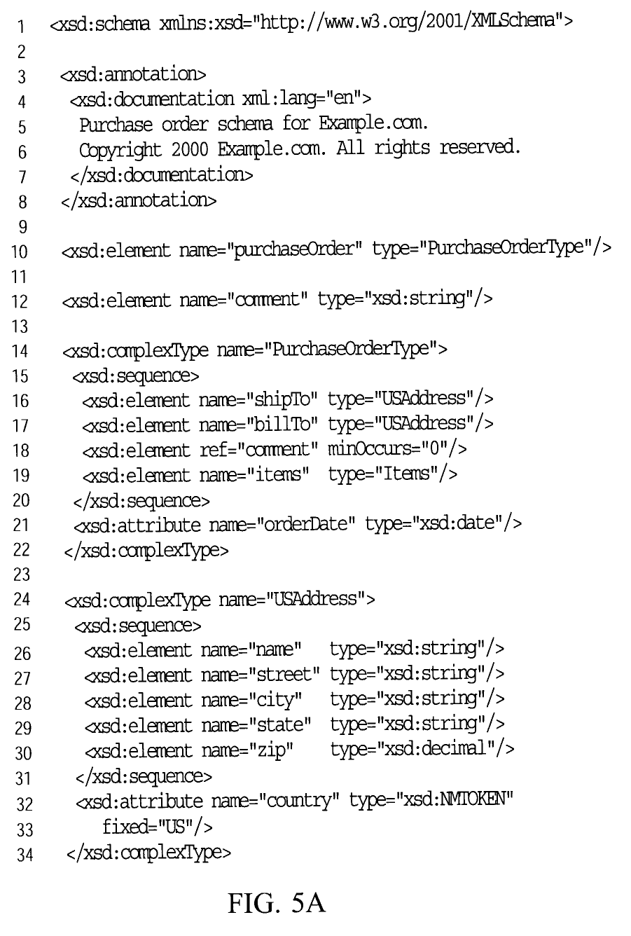

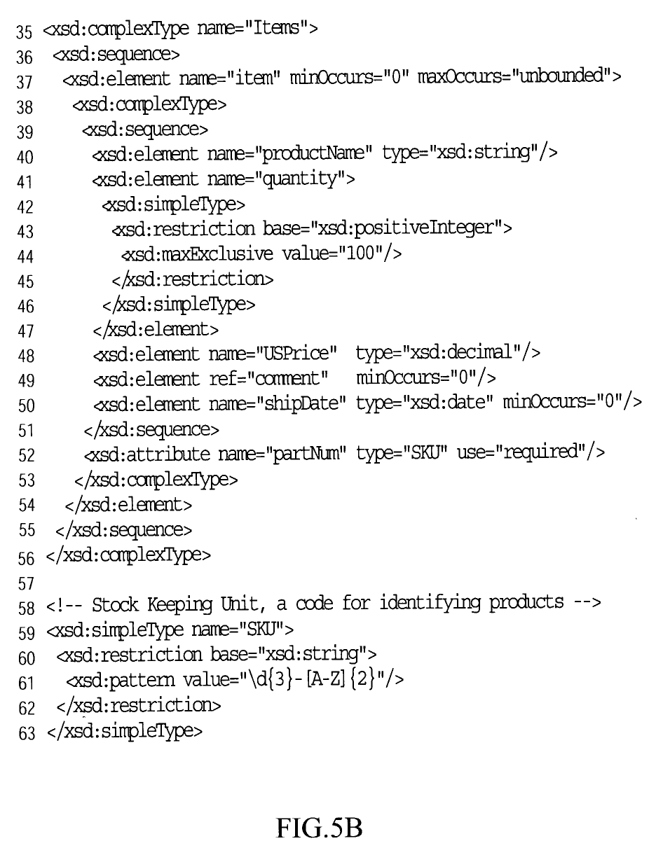

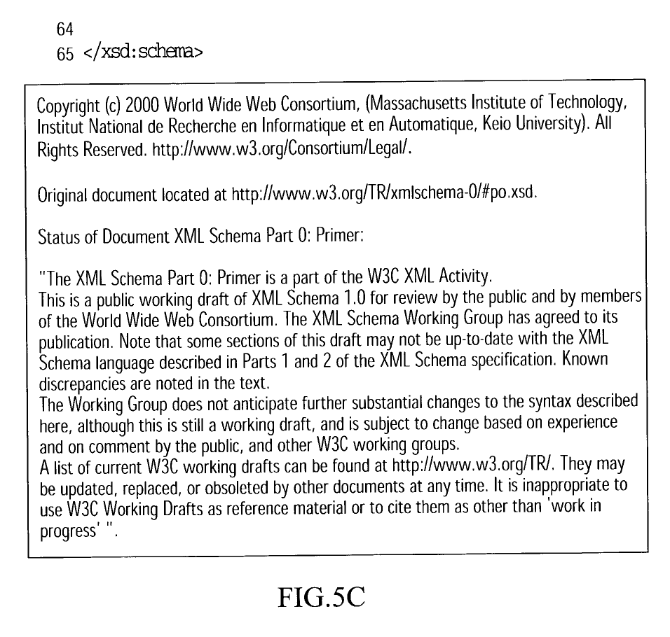

In the present case, the user 18 indicates that it is desired to read the XML source code file “purchaseorder.xsd” into the editor 10. The file “purchaseorder.xsd” is illustrated in FIGS. 5A, 5B and 5C. This file comprises an ASCII file containing XML source code which defines an XML schema describing a purchase order, which may have been created during a previous session with the XML schema editor 10. During step S404 the software 40 parses the XML source code illustrated in FIGS. 5A, 5B and 5C to identify various XML elements and attributes which comprise the schema. Thereafter the software 40 instantiates objects representative of those elements and attributes to construct an overall “object tree” image 600 of the schema in volatile memory 14 in step S406.

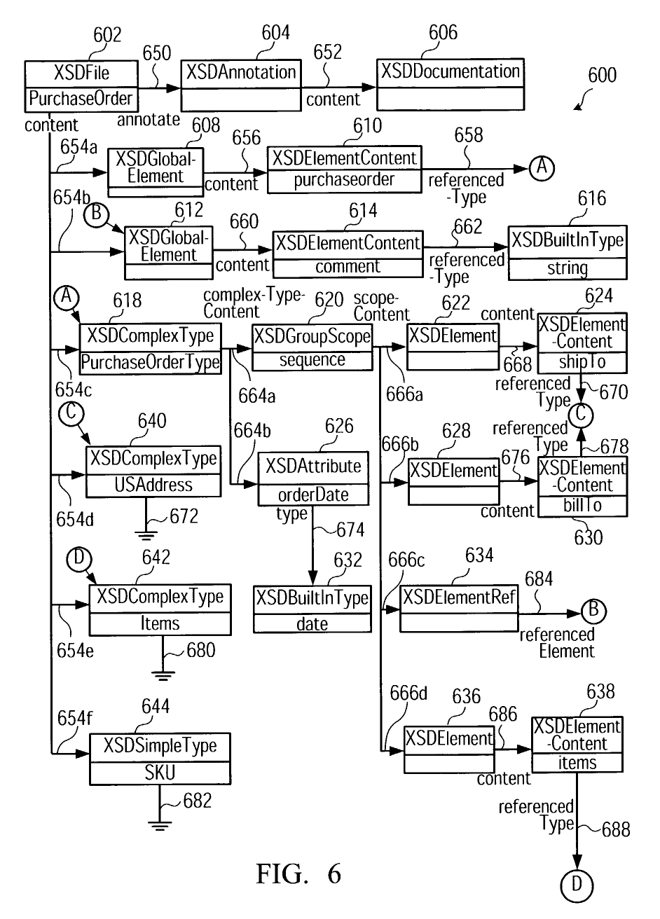

The resultant XML schema image 600 created in volatile memory 14 is illustrated in FIG. 6. It will be appreciated that the XML schema image 600 is equivalent to the XML schema image 44 referenced previously in the context of FIG. 1. As will be understood by those skilled in the art, the boxes of FIG. 6 represent objects that have been instantiated from the Java™ classes comprising software 42 (which Java™ classes themselves constitute a realization the classes defined in the XML schema object model 300). The upper portion of each object box contains the name of the class from which the object was instantiated, while the lower portion may contain the value of the object's “name” attribute, if such an attribute exists and it has been set. Interconnecting arrows in FIG. 6 represent interrelationships between objects which comprise instantiations of the inter-class associations (e.g. composition relationships, bi-directional associations, etc.) defined in the model 300.

Referring now in more detail to FIG. 6, the XML schema image 600 includes an XML schema file object 602. This object 602 represents the overall XML schema file “purchaseorder.xsd” and serves as the “root node” of the “object tree” comprising the instance 600. It will be understood that the value “PurchaseOrder” of the name attribute shown in the lower portion of object 602 has been set during the object's initialization through invocation of the object's “setNameAttribute” method (not illustrated) with the parameter “purchaseOrder”, as parsed from the filename “purchaseorder.xsd”. The attributes of other objects in the XML schema image 600 are set through a similar mechanism, i.e. by way of “setAttribute” methods associated with those objects. The values to which these attributes are set are typically read from the attributes contained in the source file of FIGS. 5A, 5B and 5C.

XML schema file object 602 contains an annotation object 604 and a series of “content” objects 608, 612, 618, 640, 642, and 644. The annotation object 604 is an instantiation of the XSDAnnotation class 306 and represents the annotation element contained in the input XML source code file at lines 3 to 8 (FIG. 5A). The containment of the annotation object 604 by the XML schema file object 602 in the image 600 is indicated by way of the “annotate” composition relationship instance 650, which is an instantiation of the composition relationship 305 of FIG. 3A. The “content” objects 608, 612, 618, 640, 642, and 644 are instantiations of various classes of the model 300 representing various types of global content contained by the XML schema file, such as global elements, complex type definitions and simple type definitions (as will be described). The containment of the global content objects 608, 612, 618, 640, 642, and 644 by the XML schema file object 602 is indicated by way of the “content” composition relationship instances 654a to 654f (cumulatively 654), which comprise six instantiations (one for each contained “global content” object) of the composition relationship 309 of FIG. 3A.

As can be observed in the input XML source code file at line 4 of FIG. 5A, the annotation object 604 in the present case is a documentation element. This fact is reflected in the XML schema instance 600 by fact that the annotation object 604 contains, by way of composition relationship instance 652 (which is an instantiation of relationship 371 of FIG. 3G), a documentation object 606 (instantiated from class 372 of FIG. 3G).

The “content” objects contained by the XML schema file object 602 via composition relationship instances 654 comprise two global element objects 608 and 612, three global complex type definition objects 618, 640, and 642, and a global simple type object 644. The first global element object 608 is representative of the “purchaseorder” global element indicated at line 10 of the input XML source code file (FIG. 5A), which is of the complex type “PurchaseOrderType”. The object 608 contains a “purchaseorder” element content object 610 representative of the content of the global element “purchaseorder”. This containment is indicated by way of the “content” composition relationship instance 656, which is an instantiation of the composition relationship 375 of FIG. 3H. The fact that the global element is of type “PurchaseOrderType” is reflected by way of the “referencedType” association relationship instance 658, which indicates a “type” association with the global complex type definition object 618 (to be described). The association relationship instance 658 is an instantiation of the bi-directional association relationship 347 of FIG. 3D.

The second global element object 612 is representative of the “comment” global element indicated at line 12 of the input XML source code file, which is of the built-in type “string”. The object 612 contains a “comment” element content object 614 representative of the content of the global element “comment”. This containment is indicated by way of the “content” composition relationship instance 660, which is an instantiation of the composition relationship 375 of FIG. 3H. The fact that the global element is of built-in type “string” is reflected by way of the built-in type object 616 and by the association of the object 614 with object 616 through “referencedType” association relationship instance 662 (an instantiation of the bi-directional association relationship 347 of FIG. 3D). The value “string” of the latter object's “kind” attribute (visible in the lower portion of the box 616) indicates that the type of XML schema built-in type being represented is “string”.

First complex type definition object 618 (as well as related objects 620, 622, 624, 626, 628, 630, 632, 634, 636 and 638) are representative of the “PurchaseOrderType” complex type definition element defined at lines 14 to 22 of the input XML source code file of FIG. 5A. The object 618 contains, through one of two “complexTypeContent” composition relationship instances 664a and 664b (cumulatively 664) instantiated from the composition relationship 325 of FIG. 3B, a group scope object 620 representative of the sequence of elements declared at lines 15 to 20 of the “purchaseorder.xsd” file. The fact that object 620 represents a sequence, as opposed to some other grouping of elements (e.g. “choice” or “all”), is apparent from the value “sequence” of the attribute “XSDGroupKind”, which is visible in the lower portion of the object 620.

The four elements in the sequence (indicated at lines 16 to 19 of FIG. 5A, respectively) are represented by objects 622, 628, 634 and 636. Each of these four objects is contained by the group scope object 620 through one of the four instantiations 666 of the “scopeContent” composition relationship 353 of FIG. 3E. The first object 622 represents the “shipTo” element declared at line 16 of the “purchaseorder.xsd” file describing a destination United States shipping address. The second object 628 is similar to the first except that its corresponding XML source code element is declared at line 17 of the “purchaseorder.xsd” file, and that it represents a billing address. The third object 634 is an element reference object representative of the element reference declared at line 18 of the “.xsd” file referencing the global element “comment” (described above). The fourth and final object 636 represents the “items” element declared at line 19 of the “purchaseorder.xsd” file comprising a list of items to be shipped.

First element object 622 contains a “shipTo” element content object 624 representative of the content of the first element “shipTo”. This containment is indicated by way of the “content” composition relationship instance 668, which is an instantiation of the composition relationship 381 of FIG. 3H. The fact that the element is of type “USAddress” is reflected by way of the “referencedType” association relationship instance 670, which indicates a “type” association with the global complex type definition object 640. The association relationship instance 670 is an instantiation of the bi-directional association relationship 347 of FIG. 3D.

Second element object 628 (“billTo”) is analogous to the “shipTo” element object 622 described above as it is of the same complex type (“USAddress”).

Third element object 634 is associated with the global “comment” element object 612. This association is evidenced by the “referencedElement” association relationship instance 684, which is an instantiation of the bi-directional association relationship 373 of FIG. 3H.

Fourth element object 636 contains an “items” element content object 638 representative of the content of the fourth element “items”. This containment is indicated by way of the “content” composition relationship instance 686, which is an instantiation of the composition relationship 381 of FIG. 3H. The fact that the element is of type “Items” is reflected by way of the “referencedType” association relationship instance 688, which indicates an association with the global complex type definition object 642. The association relationship instance 688 is an instantiation of the bi-directional association relationship 347 of FIG. 3D.

In addition to containing a first object 620 as described above, the object 618 contains a second object 626 through the second of two “complexTypeContent” composition relationship instances 664. Object 626 is an attribute object representative of the “orderDate” attribute declared at line 21 of the “purchaseorder.xsd” file of FIG. 5A. The attribute object 626 contains, by way of the “type” composition relationship instance 674 instantiated from composition relationship 337 of FIG. 3C, a built-in “date” type object 632. The fact that the built-in type is a “date” type is reflected by the value “date” of the latter object's “kind” attribute, which is visible in the lower portion of the box 632.

Second global complex type definition object 640 represents the “USAddress” complex type definition element defined at lines 24 to 34 of the input XML source code file of FIG. 5A. Various objects subordinate to the object 640 are used to represent the “USAddress” complex type definition, in a similar manner as described above with respect to the “PurchaseOrder” complex type definition. These subordinate objects are omitted from FIG. 6 for brevity.

Similarly, objects subordinate to third global complex type definition object 642 representing the “Items” complex type definition element defined at lines 35 to 56 of the “purchaseorder.xsd” (FIG. 5B) as well as global simple type object 644 representing the “SKU” simple type defined at lines 58 to 63 (FIG. 5B) of the file “purchaseorder.xsd” are omitted for brevity, as indicated by ground symbols 680 and 682 respectively.

Referring back to FIG. 4, in step S408 a content outline 210 representative of the loaded XML schema is displayed in the content outline pane 202 of the GUI 200. In this step, icons representative of XML schema objects are rendered on the display 16. It will be understood that step S408 may not discretely follow step S406 because the displaying of the content outline of step S408 may actually occur together with the instantiation of the object tree in step S406 (i.e. icons may rendered as the corresponding component objects of the XML schema object tree 600 are instantiated).

Once the XML schema is loaded and displayed by the editor 10, processing enters a loop of steps 410-414 in which system events (e.g. keyboard events, selection of GUI components, menu option selections, etc.) are received (step S410) and processed (step S412). It will be understood that the reception of events in step S410 may be by way of invocation of the methods of various “listener” objects which have been configured to execute upon the occurrence of certain system events. The nature of the processing that occurs in step S414 is dependent upon the type of event received and the GUI object with which the event is associated.

Operation of the editor 10 is terminated upon the detection of a system event comprising entry by the user 18 of an “exit editor” command in step S412. Termination will cause the objects comprising the XML schema instance 600 to be de-allocated, e.g. through the invocation of their destructor methods, causing the instance 600 to cease to exist. Accordingly, the XML schema is saved in step S416. Saving of the XML schema may be automatic or user-controlled and thus may not be performed in certain cases (e.g. in the case where no changes have been made to a displayed schema, or when the user 18 does not wish to capture any changes made in the current editing session). Saving of the XML schema entails serialization of the schema through navigation of the XML schema image 600 and generation of ASCII XML source code which corresponds to the displayed schema.

As will be appreciated by those skilled in the art, modifications to the above-described embodiment can be made without departing from the essence of the invention. For example, although the XML schema object model is expressed in the form of a Unified Modeling Language (UML) model above, it is not necessarily expressed in that form. Other notations, such as the Rumbaugh Object Modeling Technique or Booch notation, may be used to express the XML schema object model.

Other modifications will be apparent to those skilled in the art and, therefore, the invention is defined in the claims.

What is claimed is:

1. An object-oriented programming language implementation of an XML schema comprising an XML schema file class.

2. The object-oriented programming language implementation of an xml schema of claim 1, further comprising an include file class representative of an included XML schema file.

3. The object-oriented programming language implementation of an xml schema of claim 1, further comprising an import file class representative of an imported XML schema file.

4. The object-oriented programming language implementation of an xml schema of claim 1, further comprising a global content class representative of global components of an XML schema file.

5. The object-oriented programming language implementation of an xml schema of claim 4, wherein said global content class is associated with said XML schema file class in a composition relationship.

6. The object-oriented programming language implementation of an xml schema of claim 4, further comprising a global element class descendent from said global content class representative of elements that are global to an XML schema file.

7. The object-oriented programming language implementation of an xml schema of claim 6, further comprising a non-global element class representative of elements that are not global to an XML schema file.

8. The object-oriented programming language implementation of an xml schema of claim 7, further comprising an element content class representative of components that can be contained in a global element declaration or a non-global element declaration.

9. The object-oriented programming language implementation of an xml schema of claim 8, wherein said element content class is associated with either of said global element class or said non-global element class in a composition relationship.

10. The object-oriented programming language implementation of an xml schema of claim 8, further comprising a type class descendent from said global content class representative of any of a complex type definition, a simple type definition or a built-in type definition.

11. The object-oriented programming language implementation of an xml schema of claim 10, wherein said type class is associated with said element content class.

12. The object-oriented programming language implementation of an xml schema of claim 10, further comprising a complex type definition class descendent from said type class representative of a complex type definition.

13. The object-oriented programming language implementation of an xml schema of claim 12, further comprising a complex type content class representative of components that can be contained in said complex type definition class.

14. The object-oriented programming language implementation of an xml schema of claim 13, wherein said complex type content class is associated with said complex type class in a composition relationship.

15. The object-oriented programming language implementation of an xml schema of claim 13, further comprising a simple base type class descendent from said type class representative of either of an XML schema built-in type or a simple type definition.

16. The object-oriented programming language implementation of an xml schema of claim 15, further comprising a built-in type class descendent from said simple base type class.

17. The object-oriented programming language implementation of an xml schema of claim 16, further comprising a simple type definition class descendent from said built-in type class.

18. The object-oriented programming language implementation of an xml schema of claim 17, further comprising an attribute group class descendent from said global content class.

19. The object-oriented programming language implementation of an xml schema of claim 18, further comprising an attribute class descendent from said complex type content class.

20. The object-oriented programming language implementation of an xml schema of claim 19, wherein said attribute class is related to said attribute group class in a composition relationship.

21. The object-oriented programming language implementation of an xml schema of claim 13, further comprising a group content class descendent from said complex type content class representative of a content model of an XML schema complex type definition.

22. The object-oriented programming language implementation of an xml schema of claim 21, further comprising a group class descendent from said group content class representative of a group of elements of an XML schema complex type definition content model.

23. The object-oriented programming language implementation of an xml schema of 21, further comprising a group scope class descendent from said group content class representative of a grouping type of a group of elements of an XML schema complex type definition content model.

24. The object-oriented programming language implementation of an xml schema of claim 8, further comprising a unique content class representative of components of an XML schema which may be used to indicate that either of an attribute value or an element value shall be unique within a certain scope.

25. The object-oriented programming language implementation of an xml schema of claim 24, wherein said unique content class is associated with said element content class in a composition relationship.

26. The object-oriented programming language implementation of claim 19, further comprising an XML schema object class from which said XML schema file class, global content class, global element class, non-global element class, element content class, type class, complex type definition class, complex type content class, simple base type class, built-in type class, simple type class, attribute group class, and attribute class are descendent.

27. An object-oriented programming language implementation of an XML schema comprising at least one of:
a global content class representative of global components of an XML schema file;
a global element class representative of elements that are global to an XML schema;
a non-global element class representative of elements that are not global to an XML schema;
a type class representative of any of: a complex type definition; a simple type definition and a built-in type definition;
a complex type definition class;
a simple base type class representative of one of an XML schema built-in type and a simple type definition;
a simple type definition class;
a built-in type definition class;
an attribute group class;
an attribute class;
a complex type content class representative of components that can be contained in a complex type definition; and
an element content class representative of components that can be contained in an element declaration.

28. A Java™ language implementation of an XML schema comprising at least one of an XML schema file class, a global content class, a global element class, a non-global element class, an element content class, a type class, a complex type definition class, a complex type content class, a simple base type class, a built-in type class, a simple type class, an attribute group class, and an attribute class.

29. A computer readable medium storing an object-oriented programming language implementation of an XML schema comprising at least one of an XML schema file class, a global content class, a global element class, a non-global element class, an element content class, a type class, a complex type definition class, a complex type content class, a simple base type class, a built-in type class, a simple type class, an attribute group class, and an attribute class.

30. A system for visually constructing XML schemas, comprising a processor; and
memory in communication with said processor, said memory containing an object-oriented programming language implementation of an XML schema comprising at least one of: XML schema file class; a global content class; a global element class; a non-global element class; an element content class; a type class; a complex type definition class, a complex type content class; a simple base type class; a built-in type class; a simple type class; an attribute group class; and an attribute class.

31. A method of visually constructing XML schemas, said method comprising:
instantiating at least one object from any of an XML schema file class, a global content class, a global element class, a non-global element class, an element content class, a type class, a complex type definition class, a complex type content class, a simple base type class, a built-in type class, a simple type class, an attribute group class, and an attribute class; and displaying at least one icon associated with said at least one object.
